(19) United States
(12) Patent Application Publication
(10) Pub. No.: US 2021/0108801 A1
(43) Pub. Date: Apr. 15, 2021

(54) System for Rotating Detonation Combustion

(71) Applicant: General Electric Company, Schenectady, NY (US)

(72) Inventors: Kapil Kumar Singh, Rexford, NY (US); Thomas Michael Lavertu, Ballston Lake, NY (US); Thomas Earl Dyson, Niskayuna, NY (US); Sarah Marie Monahan, Latham, NY (US); Venkat Eswarlu Tangirala, Niskayuna, NY (US); Joel Meier Haynes, Niskayuna, NY (US)

(21) Appl. No.: 16/601,012

(22) Filed: Oct. 14, 2019

(51) Int. Cl. F23R 7/00; F23R 3/00; F23R 3/28

(52) U.S. Cl. CPC F23R 7/00; F05D 2220/10; F23R 3/28; F23R 3/002

(57) ABSTRACT

Systems for rotating detonation combustion are provided herein. The system includes an inner wall and an outer wall each extended around a centerline axis, wherein a detonation chamber is defined between the inner wall and the outer wall, and an iterative structure positioned at one or both of the inner wall or the outer wall. The iterative structure includes a first threshold structure corresponding to a first pressure wave attenuation and a second threshold structure corresponding to a second pressure wave attenuation. The iterative structure provides for pressure wave strengthening along a first circumferential direction in the detonation chamber or pressure wave weakening along a second circumferential direction opposite of the first circumferential direction. The first circumferential direction corresponds to a desired direction of pressure wave propagation in the detonation chamber.

### FIELD

The present subject matter relates generally to a system for continuous detonation in a heat engine such as a propulsion system.

### BACKGROUND

Many propulsion systems, such as gas turbine engines, are based on the Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such propulsion systems generally rely upon deflagrative combustion to burn a fuel/air mixture and produce combustion gas products which travel at relatively slow rates and constant pressure within a combustion chamber. While engines based on the Brayton Cycle have reached a high level of thermodynamic efficiency by steady improvements in component efficiencies and increases in pressure ratio and peak temperature, further improvements are welcomed nonetheless.

Accordingly, improvements in engine efficiency have been sought by modifying the engine architecture such that the combustion occurs as a detonation in a continuous mode. High energy ignition detonates a fuel/air mixture that transitions into a detonation wave (i.e., a fast moving shock wave closely coupled to the reaction zone). The detonation wave travels in a Mach number range greater than the speed of sound with respect to the speed of sound of the reactants. The products of combustion follow the detonation wave at the speed of sound relative to the detonation wave and at significantly elevated pressure. Such combustion products may then exit through a nozzle to produce thrust or rotate a turbine.

However, continuous detonation systems are challenged to sustain detonation in general, or to sustain detonation across various operating conditions. Without sustaining detonation of the fuel/air mixture, detonation combustion systems may be insufficiently operable for use in heat engines. As such, there is a need for methods and systems for sustaining detonation of fuel/air mixture at a detonation combustion system.

### BRIEF DESCRIPTION

Aspects and advantages of the invention will be set forth in part in the following description, or may be obvious from the description, or may be learned through practice of the invention.

Systems for rotating detonation combustion are provided herein. The system includes an inner wall and an outer wall each extended around a centerline axis, wherein a detonation chamber is defined between the inner wall and the outer wall, and an iterative structure positioned at one or both of the inner wall or the outer wall. The iterative structure includes a first threshold structure corresponding to a first pressure wave attenuation and a second threshold structure corresponding to a second pressure wave attenuation. The iterative structure provides for pressure wave strengthening along a first circumferential direction in the detonation chamber or pressure wave weakening along a second circumferential direction opposite of the first circumferential direction. The first circumferential direction corresponds to a desired direction of pressure wave propagation in the detonation chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a heat engine including a rotating detonation combustion system in accordance with an exemplary embodiment of the present disclosure;

FIG. 2 is a schematic view of an exemplary embodiment of a rotating detonation combustion system according to an aspect of the present disclosure;

FIG. 3 is a perspective view of a detonation chamber of the exemplary rotating detonation combustion system of FIG. 2;

FIG. 4 is a downstream looking upstream view of an exemplary embodiment of a rotating detonation combustion assembly according to an aspect of the present disclosure;

FIG. 5 is a downstream looking upstream view of another exemplary embodiment of a rotating detonation combustion assembly according to an aspect of the present disclosure;

FIG. 6 is a downstream looking upstream view of yet another exemplary embodiment of a rotating detonation combustion assembly according to an aspect of the present disclosure;

FIG. 7 is a downstream looking upstream view of still another exemplary embodiment of a rotating detonation combustion assembly according to an aspect of the present disclosure;

FIG. 8 is a downstream looking upstream view of an exemplary embodiment of a rotating detonation combustion assembly according to an aspect of the present disclosure;

FIG. 9 is a side view of a portion of the exemplary embodiment of a rotating detonation combustion assembly of FIG. 8;

FIG. 10 is a flowpath view of an exemplary embodiment of a rotating detonation combustion assembly according to an aspect of the present disclosure;

FIG. 11 is a side view of a portion of the exemplary embodiment of a rotating detonation combustion assembly of FIG. 10;

FIG. 12 is a flowpath view of another exemplary embodiment of a rotating detonation combustion assembly according to an aspect of the present disclosure;

FIG. 13 is a side view of a portion of the exemplary embodiment of a rotating detonation combustion assembly of FIG. 12;

FIG. 14 is a flowpath view of an exemplary embodiment of a rotating detonation combustion assembly according to an aspect of the present disclosure;

FIG. 15 is a side view of a portion of the exemplary embodiment of a rotating detonation combustion assembly of FIG. 14;

FIG. 16 is a graph depicting discharge coefficient versus fuel injector location of exemplary embodiments of a rotating detonation combustion assembly according to aspects of the present disclosure;

FIG. 17 is a flowpath view of an exemplary embodiment of a rotating detonation combustion assembly according to an aspect of the present disclosure;

FIG. 18 is a flowpath view of another exemplary embodiment of a rotating detonation combustion assembly according to an aspect of the present disclosure;

FIG. 21 is a flowpath view of yet another exemplary embodiment of a rotating detonation combustion assembly according to an aspect of the present disclosure;

FIG. 22 is a flowpath view of yet another exemplary embodiment of a rotating detonation combustion assembly according to an aspect of the present disclosure;

FIG. 23 is an exemplary embodiment of a vehicle including a rotating detonation combustion system according to an aspect of the present disclosure; and

FIG. 24 is an exemplary embodiment of a propulsion system including a rotating detonation combustion system according to an aspect of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “forward” and “aft” refer to relative positions within a propulsion system or vehicle, and refer to the normal operational attitude of the propulsion system or vehicle. For example, with regard to a propulsion system, forward refers to a position closer to a propulsion system inlet and aft refers to a position closer to a propulsion system nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Embodiments of a rotating detonation combustion (RDC) system and method for operating an RDC system are provided herein. Embodiments of the systems and methods provided herein may sustain a substantially unidirectional pressure wave detonation of a fuel/oxidizer mixture across a plurality of steady-state and transient inlet conditions. Sustaining a substantially unidirectional pressure wave detonation of the fuel/oxidizer mixture may generally include mitigating or eliminating one or more pressure waves propagating in a direction (e.g., circumferential direction) opposite of the desired unidirectional pressure wave. Counter-rotating pressure waves may generally deteriorate sustainability of continuous detonation, or deteriorate operability of the RDC system across various operating parameters (e.g., idle conditions, max power or takeoff conditions, or one or more steady state conditions in between, or transient conditions in between, etc.). Furthermore, or alternatively, counter-rotating pressure waves may lead to a lower quality detonation of the fuel/oxidizer mixture and subsequently deteriorate performance of the RDC system, the structures and methods provided herein for generating and/or maintaining a substantially unidirectional pressure wave detonation may improve RDC system performance. Such improved performance may include, but is not limited to, improved steady-state and/or transient operability, improved sustainment of the detonation wave, improved power output, or reduced emissions.

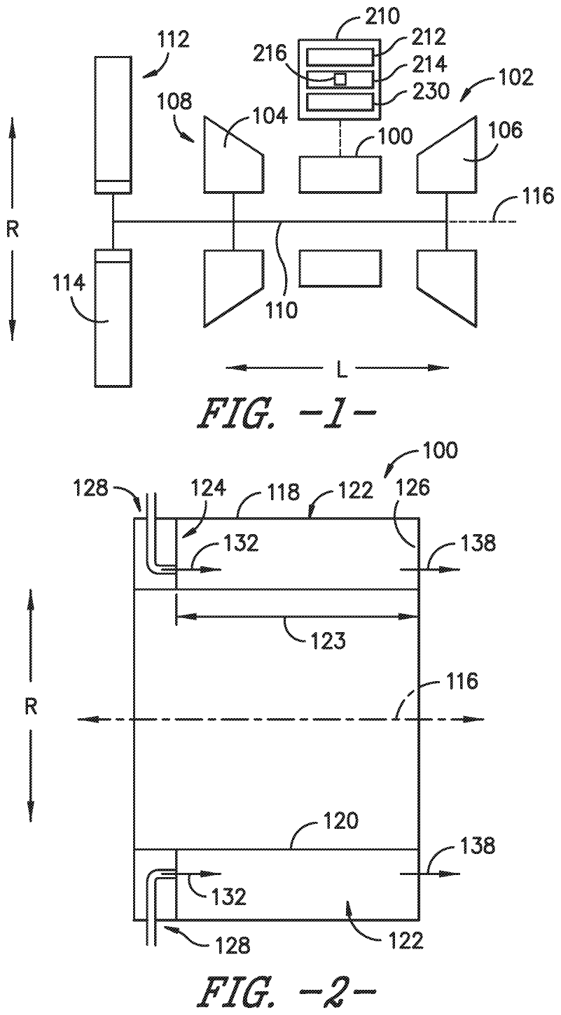

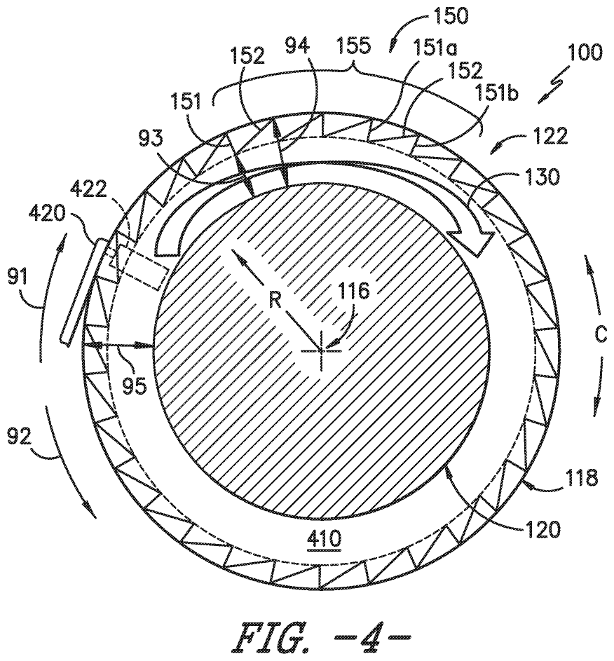

Referring to FIGS. 1-22, embodiments of a rotating detonation combustion system 100 (hereinafter, “RDC system 100”) and methods for operation 1000 (hereinafter, “method 1000”) are provided herein in accordance with exemplary embodiments of the present disclosure. The RDC system 100 and method 1000 include structures and methods for operation that may generate one or more substantially unidirectional or co-directional detonation pressure waves at a detonation chamber 122 along a circumferential direction C (FIG. 3). The single/uni-directional or multiple co-directional pressure waves may improve detonation wave sustainability generally, or more particularly, detonation wave sustainability across one or more operating parameters or transient conditions therebetween. The structures and methods provided herein may further mitigate the formation of counter-rotating pressure waves relative to multiple substantially co-directional pressure waves, such as to provide multiple substantially co-directional pressure waves relative to the circumferential direction C (FIG. 3) through the detonation chamber 122.

The RDC system 100 generally includes an outer wall 118 and an inner wall 120 spaced from one another along the radial direction R. The outer wall 118 and the inner wall 120 together define in part a detonation chamber 122, a detonation chamber inlet 124, and a detonation chamber outlet 126. The detonation chamber 122 defines a detonation chamber length 123 along the longitudinal centerline axis 116.

Further, the RDC system 100 includes a plurality of fuel injectors 128 located at the detonation chamber inlet 124. The fuel injector 128 provides a flow mixture of oxidizer and fuel to the detonation chamber 122, wherein such mixture is combusted or detonated to generate the combustion products therein, and more specifically a detonation wave 130 as will be explained in greater detail below. The combustion products exit through the detonation chamber outlet 126, such as to the turbine section 106 or exhaust nozzle such as described in regard to FIG. 1.

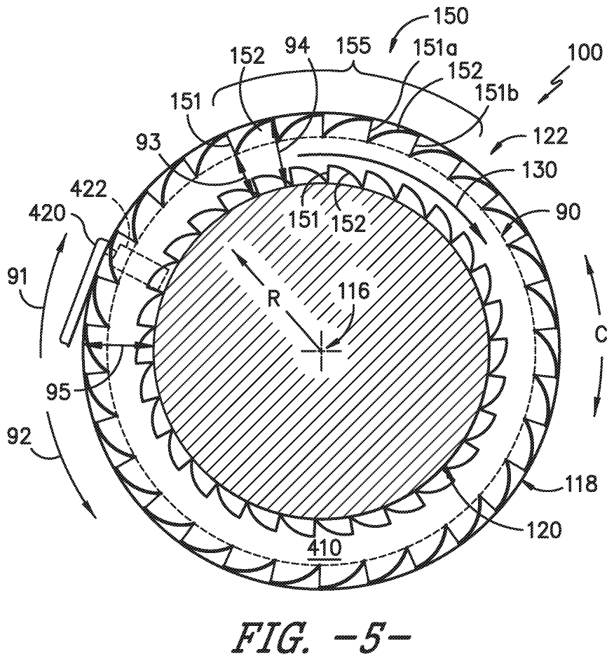

In one embodiment, such as depicted in FIG. 4, the outer wall 118 and the inner wall 120 are each generally annular and generally concentric around the longitudinal centerline axis 116. In other embodiments, the outer wall 118 and the inner wall 120 are in two-dimensional relationship relative to the centerline axis 116, such as to define a width and a height, or alternatively, a variable distance 115 relative to an angle 114, from the centerline axis 116. The outer wall 118 and the inner wall 120 together define a detonation path (e.g., detonation path 410) within the detonation chamber 122. The RDC system 100 includes a plurality of fuel injectors 128 in adjacent arrangement to one another around the centerline axis 116, such as positioned in circumferential arrangement next to one another relative to the centerline axis 116. Although further depicted herein as a circumferential flowpath arrangement, it should be appreciated that various embodiments, features, or elements shown or described in regard to FIGS. 4-22 can be arranged in either the circumferential or two-dimensional relationships.

The fuel injector 128 provides a flow mixture of oxidizer and fuel to the detonation chamber 122, wherein such mixture is combusted/detonated to generate the combustion products therein, and more specifically a detonation wave 130 as will be explained in greater detail below. The combustion products exit through the detonation chamber outlet 126. Although the detonation chamber 122 is depicted as a single detonation chamber, in other exemplary embodiments of the present disclosure, the RDC system 100 (through the outer wall 120 and inner wall 118) may include multiple detonation chambers.

Various embodiments of the RDC system 100 include structures that may attenuate or suppress pressure wave formation along a desired direction (i.e., suppressing pressure wave formation in the direction opposite of the desired uni-directional or co-directional pressure wave propagation). Embodiments of the RDC system 100 provided herein include a plurality of structures varying from one another along the circumferential direction C such as to provide for increasing pressure wave strength relative a desired circumferential direction C (i.e., a first direction 91). The plurality of structures varying from one another along the circumferential direction C may additionally, or alternatively, mitigate pressure wave strengthening or weaken pressure wave strength relative to a desired circumferential direction opposite of the strengthening direction (i.e., a second direction 92 opposite of the first direction 91).

As the detonation chamber 122 generally defines an annulus or other flowpath extended around a longitudinal axis centerline 116, the plurality of structures provide for pressure wave strengthening along the first direction 91, and/or pressure wave weakening along the second direction 92, relative to an initial position. It should be appreciated that in annular embodiments, the initial position is an initial circumferential position. It should further be appreciated that in two-dimensional embodiments, the initial position is an initial position relative to a height and width of the detonation chamber 122 and its flowpath.

In various embodiments, the initial position is defined at a predetonation device 420 extended to the detonation chamber 122. The predetonation device 420 is in operative communication with a fuel/oxidizer mixture 132 at the detonation chamber 122, such as depicted at FIG. 3. In particular embodiments, the predetonation device 420 is extended substantially tangentially to a detonation path 410 defined within the detonation chamber 122. The predetonation device 420 defines a predetonation zone 422 tangentially proximate to the predetonation device 420 at the detonation path 410. The predetonation device 420 generates the detonation wave 130 of the fuel/oxidizer mixture 132 at the detonation chamber 122, such as depicted in regard to FIG. 3. The detonation wave 130 propagates along the first direction 91 from the predetonation zone 422.

In some embodiments, the plurality of structures varying relative to one another along the circumferential direction C provides an iterative structure 150. The iterative structure provides for pressure wave strengthening along the first direction 91, and/or pressure wave weakening along the second direction 92, from a first threshold to a second threshold. The first threshold corresponds to a first pressure wave attenuation. The second threshold corresponds to a second pressure wave attenuation greater than the first pressure wave attenuation. In various embodiments, the iterative structure corresponds to one or more third threshold defined greater than the first threshold and less than the second threshold. The iterative structure may define a waveform, such as a triangle wave. In other embodiments, the iterative structure may define another waveform, such as, but not limited to, a sawtooth wave, a box wave, a sine wave, etc. In still various embodiments, the waveform may define a step wave at which the structure is increasing in amplitude before stepping down to a decreased or initial value, such as further shown and described herein. In still various embodiments, the iterative structure may include between two and forty iterations, or between two and twenty iterations, or between two and ten iterations, of the structure such as shown and described herein.

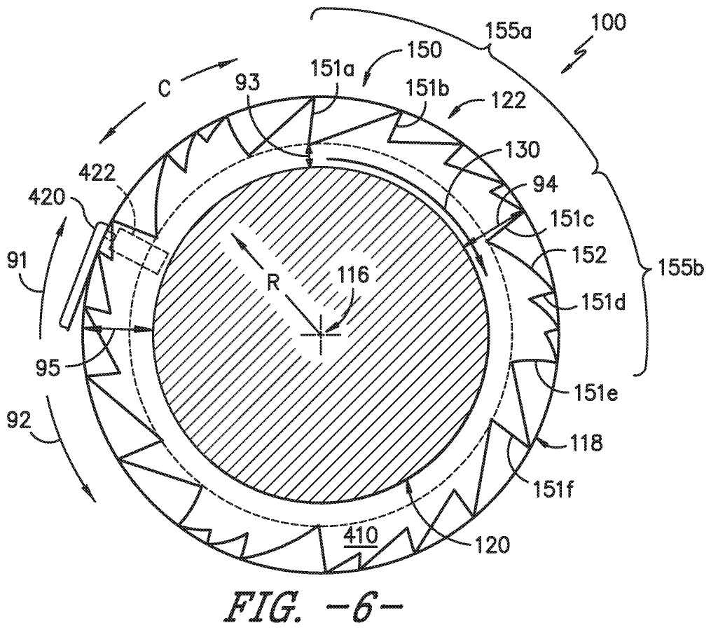

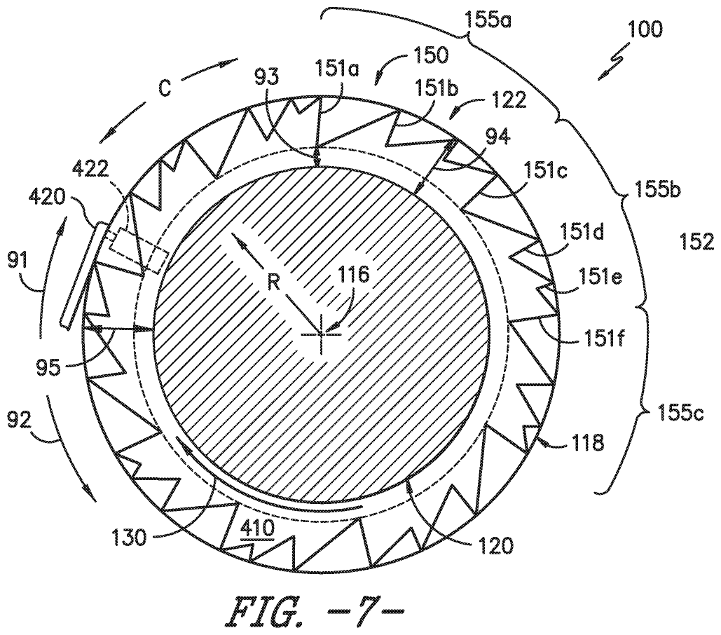

In one embodiment, such as further shown and described in regard to FIG. 4, the first threshold corresponds to a first height 93 and minimum structural limit of the detonation path 410. The second threshold corresponds to a second height 94 and maximum structural limit of the detonation path 410 greater than the first height 93. The iterative structure 150 includes a first wall 151 extended substantially radially toward the centerline axis 116. The iterative structure 150 further includes a second wall 152 extended substantially tangentially (relative to the detonation chamber 122) from one first wall 151 at the first height 93 to an adjacent or next (along the first direction 91) first wall 151 at the second height 94. In one embodiment, the second wall 152 is extended substantially linearly between the first height 93 at one first wall 151 (e.g., first wall 151a) and the second height 94 at another first wall 151 (e.g., first wall 151b). However, in other embodiments, such as depicted in regard to FIGS. 5-6, the second wall 152 may be curved, curvilinear, sinusoidal, concave, or convex between from the first height 93 and the second height 94 of the respective first walls 151a, 151b.

It should be appreciated that the second wall 152 is extended from the first height 93 at one first wall 151 (e.g., first wall 151a) to the second height 94 of another first wall 151 (e.g., first wall 151b). Additionally, or alternatively, second wall 152 is extended from the first height 93 of the first wall 151 to the respective inner wall 120 or outer wall 118 from which the first wall 151 is extended. Furthermore, the sequential arrangement of the iterative structure 150 is positioned such that the second wall 152 is extended from the first wall 151 to which the second wall 152 is attached and toward the respective inner wall 120 or outer wall 118 to which the respective first wall 151 is attached. The second wall 152 is further extended as such and corresponding to the desired circumferential direction C (i.e., the first direction 91) around which the pressure wave 132 is desirably in unidirectional or multiple co-directional orientation. As such, the particular arrangement of the iterative structure 150 including the first wall 151 and the second wall 152 may provide benefits to continuous detonation sustainability and operability such as described herein.

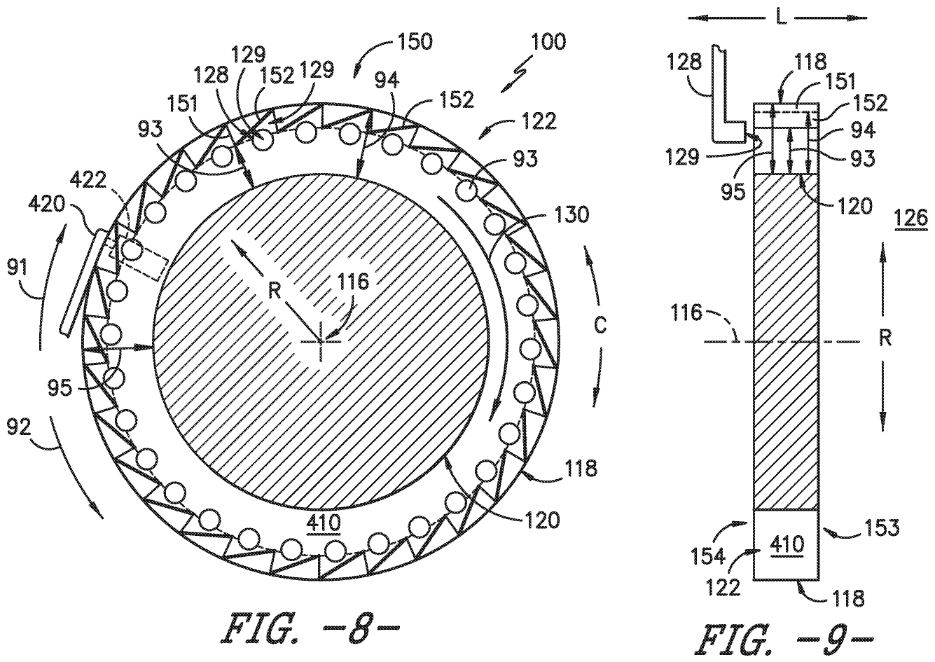

In still various embodiments, the second wall 152 may differ between respective pairs of first wall 151. For example, referring to FIG. 7, the second wall 152 may define a first profile between a first pair of first walls 151c, 151d and a second profile different from the first profile between a second pair of first walls 151e, 151f. The different profiles may generally correspond to an increasing pressure wave strength along the first direction 91 and/or a desired pressure wave weakening along the second direction 92.

Referring to FIGS. 4-7, the iterative structure 150 is defined between each pair of first walls 151 (e.g., first walls 151a, 151b). In various embodiments, the iterative structure 150 is further defined along an arc section or distance of the detonation path 410. Referring to FIG. 7, an arcuate portion 155 of the detonation chamber 122 includes the second wall 152 defining a first profile corresponding to the first threshold, a second profile corresponding to the second threshold circumferentially separated along the first direction 91, and one or more third profiles corresponding to the third threshold between the first profile and the second profile. The iterative structure 150 may provide two or more iterations of the arcuate portion 155 along the detonation path 410.

In one embodiment, the arcuate portion 155 corresponds to 180 degree arcs of the detonation flowpath 410 (i.e., two arcuate portions). In another embodiment, the arcuate portion 155 corresponds to 18 degree arcs of the detonation path 410 (i.e., twenty arcuate portions). In yet another embodiment, the arcuate portion 155 corresponds to 9 degree arcs of the detonation path 410 (i.e., forty arcuate portions). In still another embodiment, the arcuate portion 155 corresponds to approximately 1.8 degree arcs of the detonation path 410 (i.e., two-hundred arcuate portions). In various embodiments, two or more of the arcuate portions 155 may include one or more of different first height 93, second height 94, profiles of the second wall 152 (i.e., curved or curvilinear, sinusoidal, concave, convex, etc.) at one arcuate portion (e.g., arcuate portion 155a) different from another arcuate portion 155 (e.g., arcuate portion 155b).

Referring to FIGS. 4-7, it should be appreciated that in various embodiments, the first wall 151 is extended from the outer wall 118, the inner wall 120, or both. The detonation path 410 defines a flowpath height 95 extended between the inner wall 120 and the outer wall 118. In one embodiment, the first height 93 of the first wall 151 extended from either wall 118, 120 into the detonation path 410 between 3% and 50% of the flowpath height 95. In another embodiment, the first height 93 of the first wall 151 is extended from either wall 118, 120 into the detonation path 410 between 3% and 25%.

In particular embodiments, the detonation path 410 includes at least 1% of the flowpath height 95. As such, in particular embodiments in which the first wall 151 is extended from the inner wall 120 and the outer wall 118, one of the first wall 151 may be extended less than the other first wall 151 such as to provide at least 1% of the flowpath height 95 to the fuel/oxidizer mixture and detonation wave propagation. In certain embodiments, the flowpath height 95 defines a span from the inner wall 120 to the outer wall 118, such as between 0% and 100%. In various embodiments, the first wall 151 is extended from the inner wall 120 and the outer wall 118 into the detonation path 410. In one embodiment, the first wall 151 is extended from the inner wall 120 and the outer wall 118 to the first height 93 in which a 25% or less span and a 75% or greater span of the detonation path 410 is unobstructed by the first wall 151. In another embodiment, the first wall 151 is extended from the inner wall 120 and the outer wall 118 to the first height 93 in which a 20% or less span and a 80% or greater span of the detonation path 410 is unobstructed by the first wall 151. In yet another embodiment, the first wall 151 is extended from the inner wall 120 and the outer wall 118 to the first height 93 in which a 10% or less span and a 90% or greater span of the detonation path 410 is unobstructed by the first wall 151. In still another embodiment, the first wall 151 is extended from the inner wall 120 and the outer wall 118 to the first height 93 in which a 3% or less span and a 97% or greater span of the detonation path 410 is unobstructed by the first wall 151.

In still various embodiments, the extent to which the first wall 151 is extended from the inner wall 120 may be uneven or unequal relative to the first wall 151 extended from the outer wall 118. For example, the first wall 151 may be extended from the inner wall 120 into 25% of the span of the flowpath height 95 and the first wall 151 may be extended from the outer wall 118 into 95% of the span of the flowpath height 95.

In certain embodiments, the plurality of the first wall 151 and the second wall 152 around at least a portion of the detonation path 410 is in axisymmetric arrangement. However, in other embodiments, the plurality of the first wall 151 and the second wall 152 can be configured in non-axisymmetric arrangement.

Referring still to FIGS. 4-7, it should be appreciated that a flowpath view of the first wall 151 and the second wall 152 are provided. The first wall 151 is extended substantially along a radial direction R relative to the centerline axis 116. The second wall 152 is extended at least partially tangentially relative to the detonation path 410, the inner wall 120, or the outer wall 118, or generally tangential relative to the circumferential direction C.

Referring now to FIG. 8, another flowpath view of the RDC system 100 is provided. The embodiment provided in regard to FIG. 8 is configured substantially similarly as shown and described in regard to FIGS. 1-7. The RDC system 100 further includes a plurality of fuel injectors 128 configured to provide a flow of liquid and/or gaseous fuel to the detonation chamber 122. Each fuel injector 128 includes a fuel injector outlet 129 through which the flow of fuel and or fuel/oxidizer mixture enters the detonation chamber 122. In one embodiment, such as depicted in FIG. 8, the fuel injector outlet 129 is positioned within the span from the first height 93 to either the inner wall 120 or outer wall 118, such that the fuel injector outlet 129 is positioned within a pocket or area 131 in the detonation path 410 between the first wall 151 and the second wall 152. In various embodiments, the fuel injector outlet 129 is positioned within one or more ranges of the first height (i.e., between the wall 118, 120 and the first height 93 along the radial direction R) such as described above. Positioning the fuel injector outlet 129 within the area 131 may beneficially improve fuel/oxidizer mixing and detonation. The fuel injector outlet 129 may further, or alternatively, improve formation of substantially unidirectional or co-directional pressure waves in the detonation path 410. However, it should be appreciated that other embodiments may position the fuel injector outlet 129 within the span of the flowpath height 95 radially into the detonation path 410 from the first wall 151 (e.g., within 3% and 97% span, or 10% and 90% span, or 20% and 80% span, or 25% and 75% span, etc., such as described above)

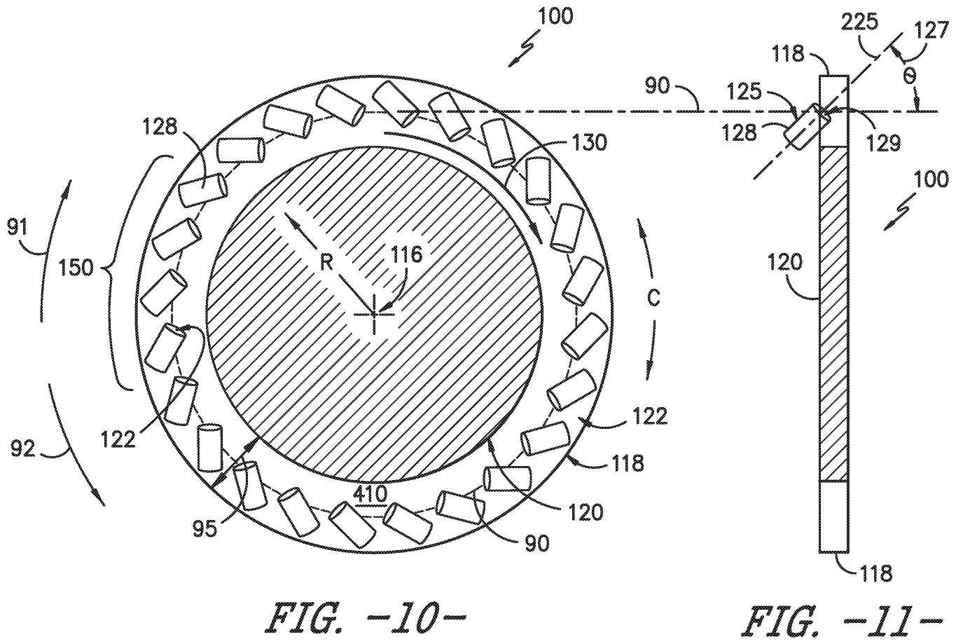

Referring now to FIG. 9, a longitudinal side view of the structure 150 is provided. The longitudinal side view of the RDC system 100 depicted in FIG. 9 may be configured substantially similarly as the RDC system 100 flowpath views depicted in FIGS. 4-8. In FIG. 9, the first wall 151 and the second wall 152 are each extended along the longitudinal direction L. The first wall 151 and the second wall 152 each define a downstream end 153 proximate to the detonation chamber outlet 126. The first wall 151 and the second wall 152 each further define an upstream end 154 distal to the detonation chamber outlet 126 and the downstream end 153. In various embodiments, the fuel injector outlet 129 is positioned forward or upstream of the downstream end 153 of the walls 151, 152. In one embodiment, the fuel injector outlet 129 may be positioned forward or upstream of the upstream end 154 of the walls 151, 152.

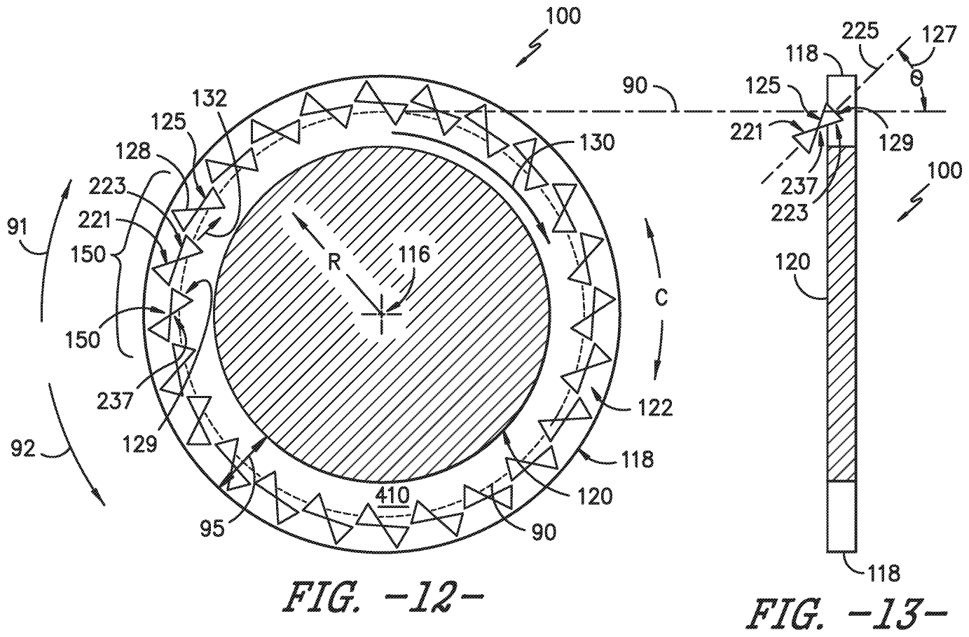

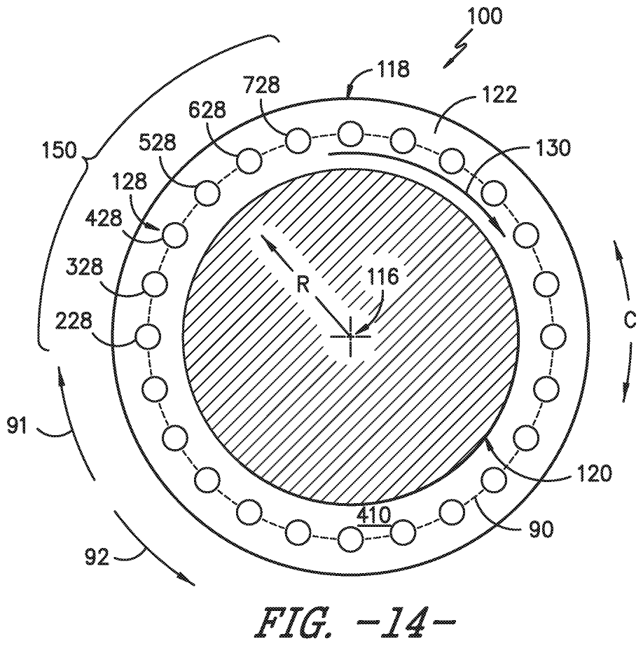

Referring now to FIGS. 10-11, a flowpath view of another exemplary embodiment of the RDC system 100 is provided. The embodiment shown and described in regard to FIG. 10 may include the first wall 151 and second wall 152 such as shown and described in regard to FIGS. 4-9. FIGS. 10-11 omit embodiments of the first wall 151 and the second wall 152 for clarity. In the embodiment depicted in regard to FIGS. 10-11, the plurality of fuel injectors 128 may be positioned in the RDC system 100 at a substantially tangential angle 127 relative to the annular detonation path 410, such as depicted via reference centerline axis 90. In certain embodiments, the fuel injector 128 includes an outer fuel injector wall 125 surrounding a fuel injector centerline axis 225. The fuel injector centerline axis 225 may generally correspond to a direction along which a fuel and/or oxidizer, or fuel/oxidizer mixture, may be provided to the detonation chamber 122 and extended through the fuel injector 128.

In various embodiments, the angle 127 is between approximately 0 degrees and approximately 90 degrees. In particular embodiments, the angle 127 is between approximately 30 degrees and approximately 60 degrees. In still various embodiments, the fuel injector outlet 129 of each fuel injector 128, or a plane thereof, is particularly positioned at the angle 127 relative to the reference centerline axis 90 of the detonation path 410. In particular embodiments, such as described in regard to FIGS. 4-9, the fuel injector outlet 129 is angled toward the desired unidirectional or co-directional pressure wave propagation, such as along the first direction 91. The angle 127 may provide the desired first direction 91 to the detonation wave 130. The angle 127 of the fuel injectors 128 may further mitigate the detonation wave 130 from traveling opposite of the angle 127 of the fuel injectors 128 and fuel outlets 129 thereof.

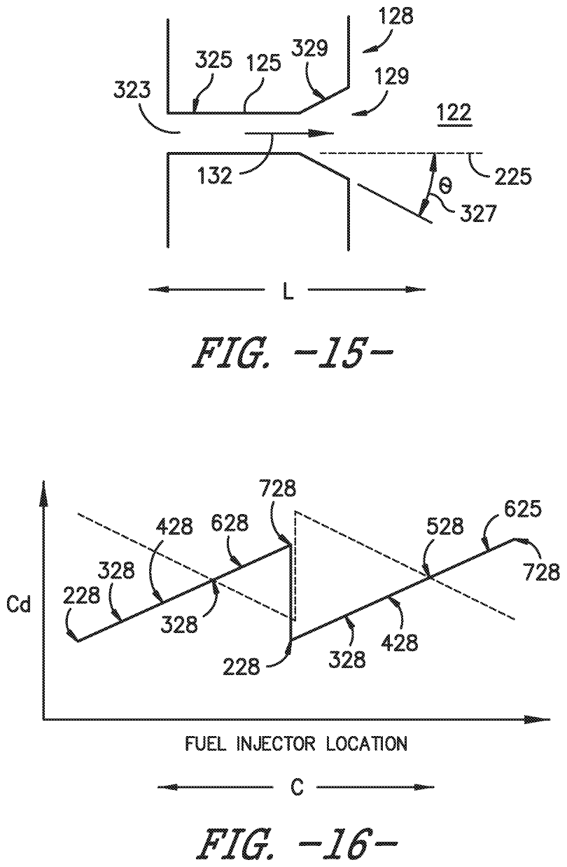

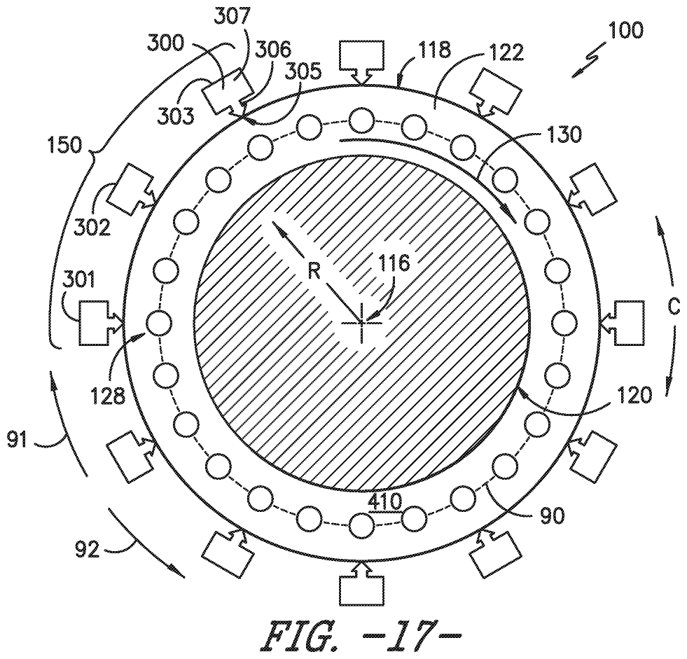

Referring now to FIG. 12, a flowpath view of another exemplary embodiment of the RDC system 100 is provided. FIG. 13 provides a side view of the embodiment depicted in FIG. 12. The embodiments provided in regard to FIGS. 12-13 are configured substantially similarly as shown and described in regard to FIGS. 4-10. As such, certain features and descriptions that may apply to various embodiments of the RDC system 100 depicted in FIGS. 1-11 may be omitted for clarity in FIGS. 12-13. The fuel injector 128 may further include a convergent-divergent (C/D) nozzle structure. The C/D nozzle structure may further define a Venturi nozzle. The C/D nozzle or Venturi nozzle may provide a Coanda effect of the fuel flow from the fuel injector 128 along the first direction 91.

The Coanda effect provided at least by the outer fuel injector wall 125 of the fuel injector 128 may provide a solid surface at least partially surrounding a jet of fuel and/or oxidizer ejecting through a nozzle 237 positioned between a convergent section 221 and divergent section 223 of the fuel injector 128. A generally low pressure region between the outer fuel injector wall 125 and a free jet stream of fuel and/or oxidizer from the nozzle 127 may provide for the free stream jet to adhere to the outer fuel injector wall 125. The fuel injector 128 defining the C/D nozzle may generally or further mitigate the detonation wave 130 from traveling opposite of the angle 127 of the fuel injectors 128 and fuel outlets 129. For example, such as depicted in regard to FIG. 12, the fuel/oxidizer mixture 132 may egress into the detonation chamber 122 at least partially along the first direction 91. The angle 127 and/or C/D nozzle of the fuel injector 128 may mitigate the detonation wave 130 from propagating along the second direction 92 opposite of the first direction 91.

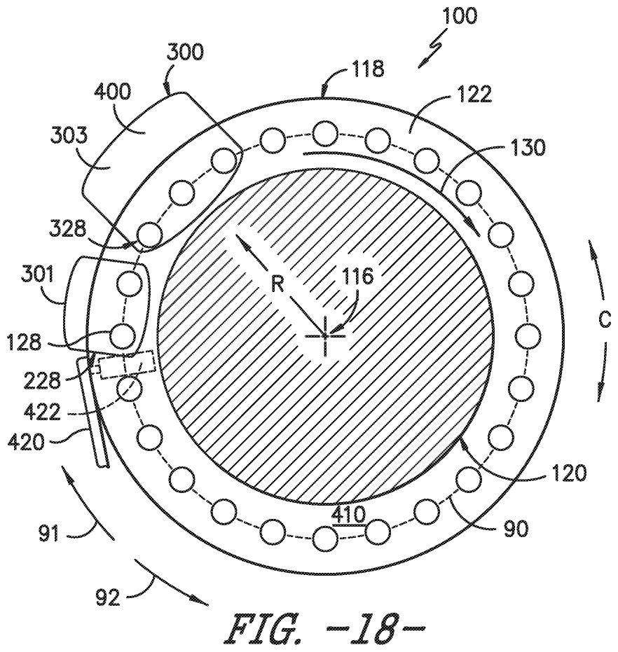

Referring now to FIG. 14, a flowpath view of another exemplary embodiment of the RDC system 100 is provided. FIG. 15 provides a side view of a portion of the embodiment depicted in FIG. 14. The embodiments provided in regard to FIGS. 14-15 are configured substantially similarly as shown and described in regard to FIGS. 1-13. As such, certain features and descriptions that may apply to various embodiments of the RDC system 100 depicted in FIGS. 5-13 may be omitted for clarity in FIGS. 14-15. In various embodiments, the RDC system 100 provides the first threshold such as described above corresponding to a first discharge coefficient of a fuel injector 128 and the second threshold corresponding to a second discharge coefficient of another fuel injector 128 greater than the first discharge coefficient.

In certain embodiments, such as depicted in regard to FIGS. 15, the outer fuel injector wall 125 includes a relatively straight or longitudinal portion defining a fuel passage 323. The outer fuel injector wall 125 further includes an angled wall 329 relative to the fuel injector centerline axis 225. An angle 327 of the angled wall 329 relative to the fuel injector centerline axis 225 corresponding to a discharge coefficient of the fuel hole is defined. In various embodiments, the angle 327 corresponding to the discharge coefficient is varied between 0 degrees and 90 degrees.

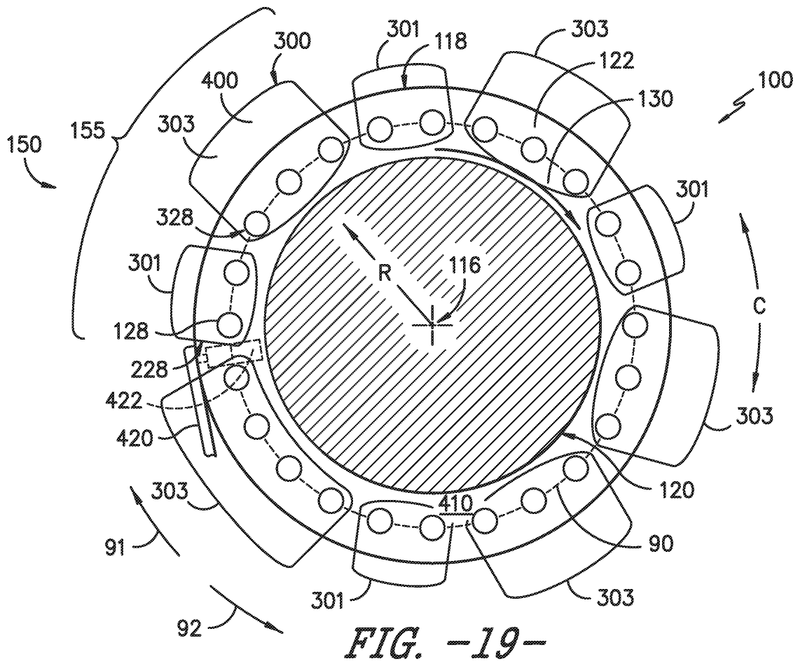

Referring to FIG. 16, a graph depicting variation in the discharge coefficient relative to the circumferential location of the fuel injector is provided. It should be appreciated that the graph depicted in regard to FIG. 16 may generally apply to the iterative structure 150 shown and described herein in regard to FIGS. 1-15. In various embodiments, the discharge coefficient corresponds to the angle 327 of the angled wall 329 and the fuel injector 128. In one embodiment, the RDC system 100 including the iterative structure includes two or more pluralities of fuel injectors 128 in circumferential arrangement. Each plurality of fuel injectors 128 includes a quantity of fuel injectors defining increasing discharge coefficients (Cd) along the desired direction of pressure wave propagation (e.g., the first direction 91). For example, referring to FIGS. 14-16, the iterative structure includes two or more iterations of the plurality of fuel injectors 128, such as depicted as fuel injectors 228, 328, 428, 528, 628, 728. Minimum Cd fuel injector 228 may generally define a minimum discharge coefficient (Cd) of the iteration of fuel injectors. Maximum Cd fuel injector 728 may generally define a maximum Cd of the iteration of fuel injectors. As further depicted in FIG. 16, the circumferentially sequential fuel injector after the maximum fuel injector 728 (i.e., sequential relative to the desired direction of pressure wave propagation) may include the minimum Cd fuel injector 228. In various embodiments, the RDC system 100 may include one or more intermediate Cd fuel injectors 328, 428, 528, 628 positioned circumferentially between the minimum Cd fuel injector 228 and the maximum Cd fuel injector 728. The intermediate Cd fuel injector defines one or more discharge coefficients between the minimum Cd and the maximum Cd. In one embodiment, a plurality of intermediate Cd fuel injectors (e.g., 328, 428, 528, 628, etc.) define equal or increasing Cd in circumferential sequence between the minimum Cd fuel injector 228 and the maximum Cd fuel injector 728.

In one embodiment, the change in Cd from the minimum Cd fuel injector 228 to the maximum Cd fuel injector 728 is between 2× and 3×. In one embodiment, the maximum Cd fuel injector 728 defines a discharge coefficient three times greater than the minimum Cd fuel injector 228. In another embodiment, the maximum Cd fuel injector 728 defines a discharge coefficient 2.5 times greater than the minimum Cd fuel injector 228. In yet another embodiment, the maximum Cd fuel injector 728 defines a discharge coefficient two times greater than the minimum Cd fuel injector 228.

In still various embodiments, such as stated previously, the RDC system 100 may include between two and forty of the iterative structure 150. In one embodiment, the RDC system 100 includes two of the iterative structure 150 repeating in 180 degree segments or arcs. In still another embodiment, the RDC system 100 includes four of the iterative structure 150 repeating in 90 degree segments or arcs. In another embodiment, the RDC system 100 includes eight of the iterative structure 150 repeating in 45 degree segments or arcs. In yet another embodiment, the RDC system 100 includes twenty of the iterative structure 150 repeating in 18 degree segments or arcs. In still yet another embodiment, the RDC system 100 includes forty of the iterative structure 150 repeating in 9 degree segments or arcs.

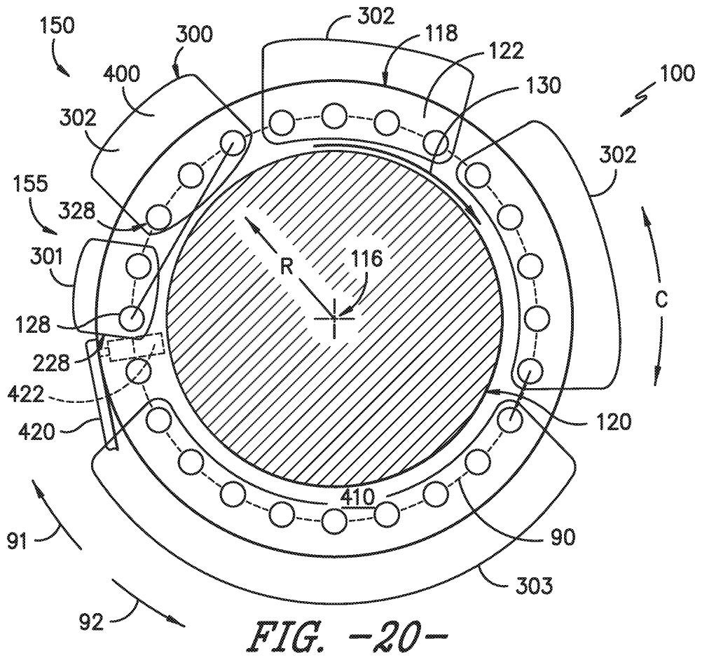

Referring now to FIGS. 17-22, flowpath views of exemplary embodiments of the RDC system 100 are further provided. The embodiments provided in regard to FIGS. 17-22 are configured substantially similarly as shown and described in regard to FIGS. 1-16. As such, certain features and descriptions that may apply to various embodiments of the RDC system 100 depicted in FIGS. 5-16 may be omitted for clarity in FIGS. 17-22. In FIGS. 17-22, various embodiments of the RDC system 100 including dampers 300 are provided. In certain embodiments, the dampers 300 define Helmholtz resonators defining containers of fluid with an opening 305 in fluid communication with the detonation chamber 122. The damper 300 defining a Helmholtz damper is configured to a target frequency, or range thereof, corresponding to pressures or pressure waves that may be generated along the undesired direction (i.e., opposite of the desired direction, such as second direction 92). The damper 300 may be defined by the equation:

$$f = \frac{c}{2 π} √ ( \frac{A}{{VL}^{′}} )$$

where f is the frequency, or range thereof, of pressure oscillations to be attenuated; c is the velocity of sound in the fluid (i.e., oxidizer or detonation gases); A is a cross sectional area of the opening 305 of a damper passage 306 leading to a plenum 307; V is the volume of the damper passage 306, the plenum 307, or both; and L′ is the effective length of the damper passage 306. In various embodiments, the effective length is the length of the damper passage 306 plus a correction factor generally understood in the art multiplied by the diameter of the area of the damper passage 306.

In various embodiments, the damper 300 includes a plurality of dampers defining at least a minimum attenuation target (e.g., at damper 301) and a maximum attenuation target (e.g., at damper 303). The plurality of dampers may further include one or more of an intermediate attenuation target (e.g., at damper 302) targeting one or more frequencies between the minimum attenuation target at damper 301 and the maximum attenuation target at damper 303. The plurality of dampers 301, 302, 303 are configured substantially similarly as shown and described in regard to the graph in FIG. 16. As such, the plurality of dampers are arranged in increasing or decreasing sequential arrangement along the circumferential direction to mitigate pressure wave propagation along the undesired direction (e.g., the second direction 92). In still various embodiments, the RDC system 100 includes two or more pluralities of the dampers 301, 302, 303 arranged such as described above in regard to FIGS. 1-16.

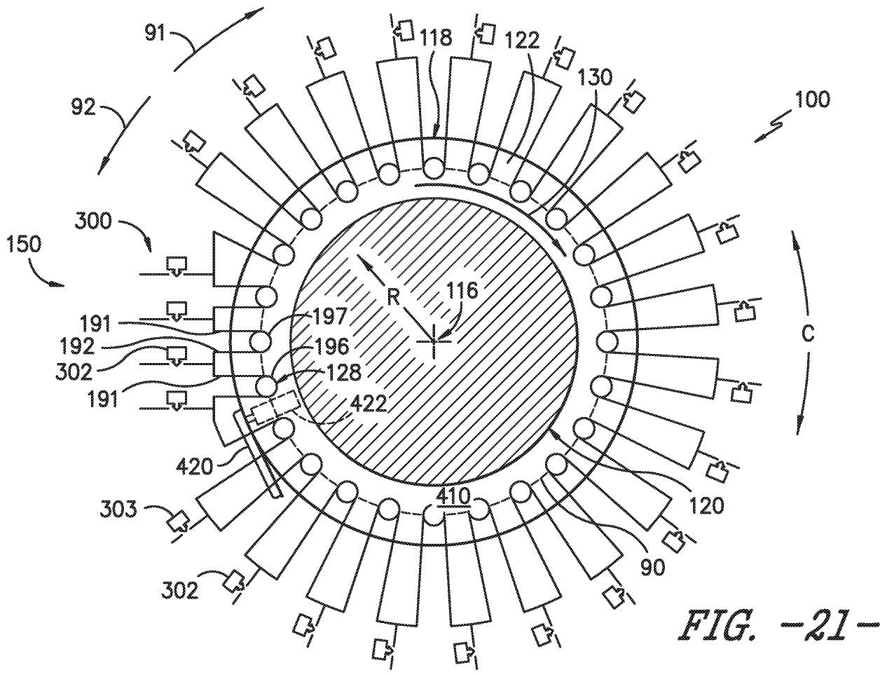

Referring to FIGS. 18-20, in certain embodiments, the damper 300 defines a fuel cavity 400 from which a flow of liquid and/or gaseous fuel is provided to the fuel injector 128. In various embodiments, the damper 300 defining the fuel cavity 400 provides fuel to one or more fuel injectors 128 in sequential circumferential arrangement. The damper 300 may provide fuel to certain quantities of fuel injectors 128, such as depicted at dampers 301, 302, 303. The dampers 300 defining fuel cavities 400 are configured such as shown and described in regard to FIGS. 1-17.

Referring still to FIGS. 18-20, various embodiments of the plurality of dampers 300 are positioned in circumferential arrangement from the predetonation device 420 or predetonation zone 422. In certain embodiments, the plurality of dampers 300 are positioned in circumferential arrangement from the predetonation device 420 or predetonation zone 422 in order of increasing target frequency corresponding to the desired direction of pressure wave propagation (e.g., along the first direction 91). Referring to FIGS. 18-20, the plurality of dampers 300 includes the minimum attenuation target damper 301 positioned adjacent or next to the predetonation device 420 along the desired direction of pressure wave propagation (e.g., the first direction 91).

In certain embodiments, such as depicted in regard to FIG. 19, the plurality of dampers 300 is arranged in arcuate portions 155 including the iterative structure 150 along the circumferential direction C. The arcuate portions 155 include the minimum attenuation target damper 301 and the maximum attenuation target damper 303, such as depicted in regard to FIG. 19. In some embodiments, the arcuate portions 155 further include one or more of the intermediate attenuation target dampers 302 positioned circumferentially between the minimum attenuation target damper 301 and the maximum attenuation target damper 303, such as depicted in regard to FIG. 20. In still some embodiments, the plurality of dampers 300 is positioned in order of increasing target attenuation frequency along the desired direction of pressure wave propagation (e.g., first direction 91). In an exemplary embodiment depicted in FIG. 20, the minimum attenuation target damper 301 is positioned immediately next to or adjacent the predetonation device 420 or predetonation zone 422 along the desired direction of pressure wave propagation (e.g., first direction 91). The maximum attenuation target damper 303 may be positioned immediately next to or adjacent the predetonation device 420 or predetonation zone 422 along the second direction 92 or opposite of desired direction of pressure wave propagation. In certain embodiments, one or more subsequent intermediate attenuation target dampers 302 may be placed circumferentially between the minimum attenuation target damper 301 and the maximum attenuation target damper 303.

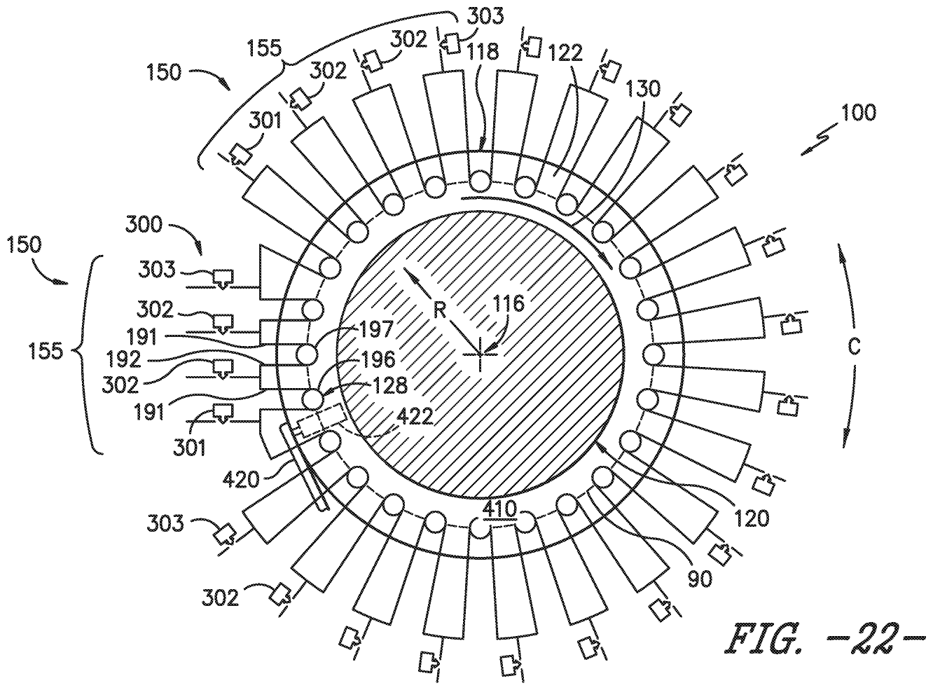

Referring to FIG. 21, in various embodiments, the plurality of dampers 300 is configured as a fluid diode with the plurality of fuel nozzles 128. In various embodiments, each damper 300 is fluidly connected via a fuel circuit 190 to the fuel nozzles 128. The system 100 includes a first fuel circuit 191 configured to provide a flow of fuel in fluid communication to a first fuel nozzle (e.g., fuel nozzle 196). The system 100 further includes a second fuel circuit 192 configured to provide a flow of fuel in fluid communication to a second fuel nozzle (e.g., fuel nozzle 197) circumferentially adjacent to the first fuel nozzle 196. Furthermore, the plurality of dampers 300 includes a first damper fluidly coupled to the first fuel nozzle 196 via the second fuel circuit 192 and fluidly coupled to the second fuel nozzle 197 via the first fuel circuit 191. In certain embodiments, the first fuel nozzle 196 is positioned immediately adjacent or next to the predetonation device 420.

In various embodiments, such as shown and described in regard to FIGS. 17-20, or more generally in regard to FIGS. 4-20, the plurality of dampers 300 is arranged in order of increasing or decreasing pressure frequency attenuation along the desired direction of pressure wave propagation (e.g. first direction 91). In an exemplary embodiment, a fuel nozzle 128 receives a flow of fuel from the first fuel circuit 191 and from a first damper and further receive fuel from the second fuel circuit 192 and from the second damper, in which the second damper is positioned circumferentially next to the first damper along the desired direction of pressure wave propagation (e.g., first direction 91).

In one embodiment, the plurality of dampers 300 includes the minimum attenuation target damper 301 and the maximum attenuation target damper 303. The plurality of dampers 300 are positioned in increasing pressure wave target frequency order along the desired direction of pressure wave propagation (e.g., first direction 91). In certain embodiments, the plurality of dampers 300 includes the first damper or minimum attenuation target damper 301 positioned immediately adjacent to the predetonation device 420 along the desired direction of pressure wave propagation. The second damper or maximum attenuation target damper 303 is positioned immediately adjacent to the predetonation device 420 along a direction opposite of the desired direction of pressure wave propagation, or the direction of desired pressure wave attenuation (e.g., the second direction 92). In various embodiments, one or more intermediate attenuation target dampers 302 are positioned circumferentially between the dampers 301, 303. In various embodiments, the first damper is configured to a pressure frequency attenuation less than the second damper. For example, the first damper is generally the minimum attenuation target damper 301 or the intermediate attenuation target damper 302, and the second damper is generally the intermediate attenuation target damper 302 (i.e., greater than the minimum attenuation target damper 301 or greater than or equal to another intermediate target damper 302) or the maximum attenuation target damper 303.

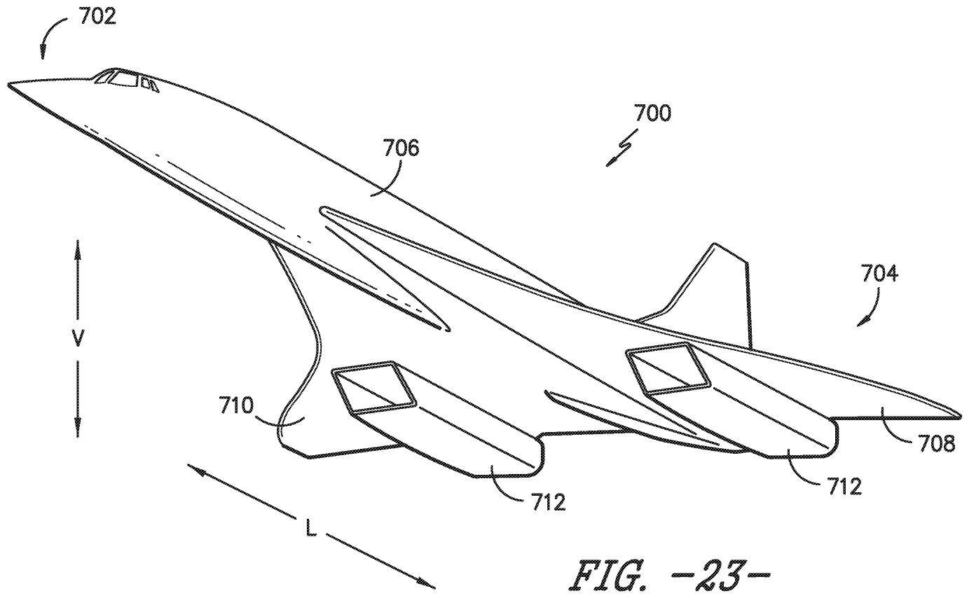

In another embodiment, the plurality of dampers 300 is configured such as shown and described in regard to FIGS. 4-21. In some embodiments, such as depicted in FIG. 22, the plurality of dampers 300 is arranged in arcuate portions 155 along the circumferential direction C. Each arcuate portion 155 includes the minimum attenuation target damper 301 and the maximum attenuation target damper 302. In further embodiments, each arcuate portion 155 includes one or more of the intermediate attenuation target dampers 302 circumferentially between the dampers 301, 303. It should be appreciated that in the embodiments provided, each damper 300 is configured in fluid communication with at least a pair of fuel nozzles 128.

Referring back to FIGS. 17-22, in various embodiments, the plurality of dampers 300 includes the minimum attenuation target damper 301 and a maximum attenuation target damper 303 in which the minimum attenuation target damper 301 is positioned circumferentially sequential (e.g., along the first direction 91) to the maximum attenuation target damper 303. In certain embodiments, the minimum attenuation target damper 301 is further positioned immediately adjacent or next to the predetonation device 420 along the circumferential direction C. In still various embodiments, one or more intermediate attenuation target dampers 302 is positioned circumferentially between dampers 301, 303.

Referring back to FIG. 1, the engine is generally configured as a propulsion system or heat engine 102. More specifically, the heat engine 102 generally includes an inlet or compressor section 104 and an outlet or turbine section 106. In various embodiments, the RDC system 100 is positioned downstream of the compressor section 104. In some embodiments, such as depicted in regard to FIG. 1, the RDC system 100 is positioned upstream of the turbine section 106. In other embodiments, such as further shown and described in regard to FIG. 24, the RDC system 100 is positioned upstream and/or downstream of the turbine section 106. During operation, airflow may be provided to an inlet 108 of the compressor section 104, wherein such airflow is compressed through one or more compressors, each of which may include one or more alternating stages of compressor rotor blades and compressor stator vanes. However, in various embodiments, the compressor section 104 may define a nozzle through which the airflow is compressed as it flows to the RDC system 100.

As will be discussed in greater detail below, compressed air from the compressor section 104 may then be provided to the RDC system 100, wherein the compressed air may be mixed with a fuel and detonated to generate combustion products. The combustion products may then flow to the turbine section 106 wherein one or more turbines may extract kinetic/rotational energy from the combustion products. As with the compressor(s) within the compressor section 104, each of the turbine(s) within the turbine section 106 may include one or more alternating stages of turbine rotor blades and turbine stator vanes. However, in various embodiments, the turbine section 106 may define an expansion section through which detonation gases are expanded and provide propulsive thrust from the RDC system 100. In still various embodiments, the combustion gases or products may then flow from the turbine section 106 through, e.g., an exhaust nozzle to generate thrust for the heat engine 102.

As will be appreciated, rotation of the turbine(s) within the turbine section 106, generated by the combustion products, is transferred through one or more shafts or spools 110 to drive the compressor(s) within the compressor section 104. In various embodiments, the compressor section 104 may further define a fan section, such as for a turbofan engine configuration, such as to propel air across a bypass flowpath outside of the RDC system 100 and turbine section 106.

It will be appreciated that the heat engine 102 depicted schematically in FIG. 1 is provided by way of example only. In certain exemplary embodiments, the heat engine 102 may include any suitable number of compressors within the compressor section 104, any suitable number of turbines within the turbine section 106, and further may include any number of shafts or spools 110 appropriate for mechanically linking the compressor(s), turbine(s), and/or fans. Similarly, in other exemplary embodiments, the heat engine 102 may include any suitable fan section, with a fan thereof being driven by the turbine section 106 in any suitable manner. For example, in certain embodiments, the fan may be directly linked to a turbine within the turbine section 106, or alternatively, may be driven by a turbine within the turbine section 106 across a reduction gearbox. Additionally, the fan may be a variable pitch fan, a fixed pitch fan, a ducted fan (i.e., the heat engine 102 may include an outer nacelle surrounding the fan section), an un-ducted fan, or may have any other suitable configuration.

Moreover, it should also be appreciated that the RDC system 100 may further be incorporated into any other suitable aeronautical propulsion system, such as a supersonic propulsion system, a hypersonic propulsion system, a turbofan engine, a turboshaft engine, a turboprop engine, a turbojet engine, a ramjet engine, a scramj et engine, etc., or combinations thereof, such as combined-cycle propulsion systems. Further, in certain embodiments, the RDC system 100 may be incorporated into a non-aeronautical propulsion system, such as a land-based power-generating propulsion system, an aero-derivative propulsion system, etc. Further, still, in certain embodiments, the RDC system 100 may be incorporated into any other suitable propulsion system or vehicle, such as a manned or unmanned aircraft, a rocket, missile, a launch vehicle, etc. With one or more of the latter embodiments, the propulsion system may not include a compressor section 104 or a turbine section 106, and instead may simply include a convergent and/or divergent flowpath leading to and from, respectively, the RDC system 100. For example, the turbine section 106 may generally define the nozzle 135 through which the combustion products flowing therethrough to generate thrust.

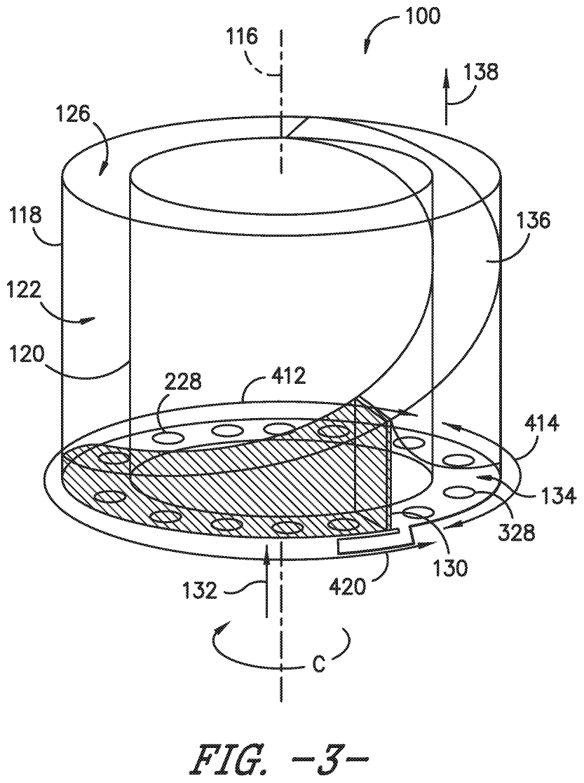

Referring now to FIG. 2, a side, schematic view is provided of an exemplary RDC system 100 as may be incorporated into the exemplary embodiment of FIG. 1. As shown, the RDC system 100 generally defines a longitudinal centerline axis 116 that may be common to the heat engine 102, a radial direction R relative to the longitudinal centerline axis 116, and a circumferential direction C relative to the longitudinal centerline axis 116 (see, e.g., FIG. 3), and a longitudinal direction L (shown in FIG. 1).

Referring briefly to FIG. 3, providing a perspective view of the detonation chamber 122 (without the fuel injector 128), it will be appreciated that the RDC system 100 generates the detonation wave 130 during operation. The detonation wave 130 travels in the circumferential direction C of the RDC system 100 consuming an incoming fuel/oxidizer mixture 132 and providing a high pressure region 134 within an expansion region 136 of the combustion. A burned fuel/oxidizer mixture 138 (i.e., detonation gases) exits the detonation chamber 122 and is exhausted.

More particularly, it will be appreciated that the RDC system 100 is of a detonation-type combustor, deriving energy from the continuous wave 130 of detonation. For a detonation combustor, such as the RDC system 100 disclosed herein, the combustion of the fuel/oxidizer mixture 132 is effectively a detonation as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction. By contrast, with a detonation combustor, the detonation is a shock induced flame, which results in the coupling of a reaction zone and a shockwave. The shockwave compresses and heats the fresh mixture 132, increasing such mixture 132 above a self-ignition point. On the other side, energy released by the detonation contributes to the propagation of the detonation shockwave 130. Further, with continuous detonation, the detonation wave 130 propagates around the detonation chamber 122 in a continuous manner, operating at a relatively high frequency. Additionally, the detonation wave 130 may be such that an average pressure inside the detonation chamber 122 is higher than an average pressure within typical combustion systems (i.e., deflagration combustion systems).

Accordingly, the region 134 behind the detonation wave 130 has very high pressures. As will be appreciated from the discussion below, the fuel injector 128 of the RDC system 100 is designed to prevent the high pressures within the region 134 behind the detonation wave 130 from flowing in an upstream direction, i.e., into the incoming flow of the fuel/oxidizer mixture 132.

Referring back to FIG. 1, in conjunction with FIGS. 2-22, the RDC system 100 further includes a controller configured to adjust, modulate, or otherwise desirably provide fuel or fuel/oxidizer mixtures through the fuel nozzles, separately or in conjunction with two or more fuel nozzles. In general, the controller 210 can correspond to any suitable processor-based device, including one or more computing devices. For instance, FIG. 1 illustrates one embodiment of suitable components that can be included within the controller 210. As shown in FIG. 1, the controller 210 can include a processor 212 and associated memory 214 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, microcontroller, a microcomputer, a programmable logic controller (PLC), an application specific integrated circuit (ASIC), a Field Programmable Gate Array (FPGA), and other programmable circuits. Additionally, the memory 214 can generally include memory element(s) including, but not limited to, computer readable medium (e.g., random access memory (RAM)), computer readable non-volatile medium (e.g., flash memory), a compact disc-read only memory (CD-ROM), a magneto-optical disk (MOD), a digital versatile disc (DVD) and/or other suitable memory elements or combinations thereof. In various embodiments, the controller 210 may define one or more of a full authority digital engine controller (FADEC), a propeller control unit (PCU), an engine control unit (ECU), or an electronic engine control (EEC).

As shown, the controller 210 can include control logic 216 stored in memory 214. The control logic 216 may include instructions that when executed by the one or more processors 212 cause the one or more processors 212 to perform operations, such as steps for providing fuel and/or oxidizer to operate a substantially unidirectional pressure wave RDC system 100.

Additionally, as shown in FIG. 1, the controller 210 can also include a communications interface module 230. In several embodiments, the communications interface module 230 can include associated electronic circuitry that is used to send and receive data. As such, the communications interface module 230 of the controller 210 can be used to send and/or receive data to/from engine 102 and the RDC system 100. In addition, the communications interface module 230 can also be used to communicate with any other suitable components of the engine 102, including any number of sensors, valves, flow control devices, orifices, etc. configured to determine, calculate, modify, alternate, articulate, adjust, or otherwise provide a desired fuel characteristic and/or oxidizer characteristic to the detonation chamber 122, including, but not limited to, fluid flow rate, fluid pressure, fluid temperature, fluid density, fluid atomization, etc. It should be appreciated that the communications interface module 230 can be any combination of suitable wired and/or wireless communications interfaces and, thus, can be communicatively coupled to one or more components of the RDC system 100 and engine 102 via a wired and/or wireless connection. As such, the controller 210 may obtain, determine, store, generate, transmit, or operate any one or more steps of the method 1000 at the engine 102, an apparatus to which the engine 102 is attached (e.g., an aircraft), or a ground, air, or satellite-based apparatus in communication with the engine 102 (e.g., a distributed network).

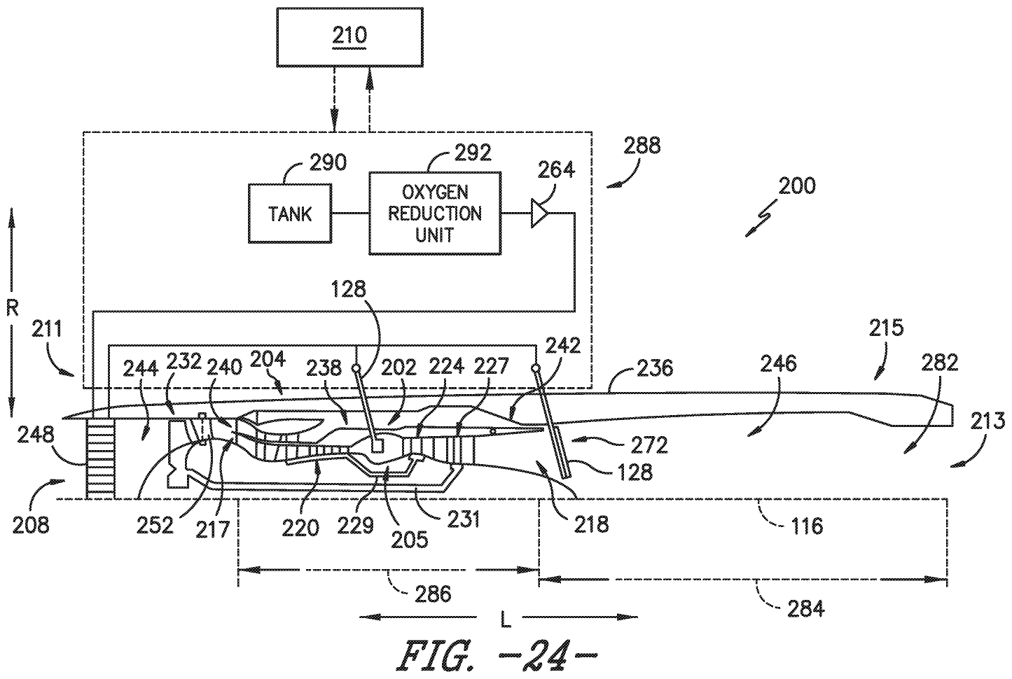

Referring now to FIG. 23, a perspective view of a hypersonic vehicle or hypersonic aircraft 700 in accordance with an exemplary aspect of the present disclosure is provided. The exemplary hypersonic aircraft 700 of FIG. 1 generally defines a vertical direction V, a lateral direction (not labeled), and a longitudinal direction L. Moreover, the hypersonic aircraft 700 extends between a forward end 702 and aft end 704 generally along the longitudinal direction L. For the embodiment shown, the hypersonic aircraft 700 includes a fuselage 706, a first wing 708 extending from a port side of the fuselage 706, and second wing 710 extending from a starboard side of the fuselage 706, and a vertical stabilizer. The hypersonic aircraft 700 includes a propulsion system, which for the embodiment shown includes a pair of hypersonic propulsion engines 102, with a first of such engines 102 mounted beneath the first wing 708 and a second of such engines 102 mounted beneath the second wing 710. As will be appreciated, the propulsion system may be configured for propelling the hypersonic aircraft 700 from takeoff (e.g., 0 miles per hour up to around 250 miles per hour) up and to hypersonic flight. It will be appreciated, that as used herein, the term “hypersonic” refers generally to air speeds of about Mach 4 up to about Mach 10, such as Mach 5 and up.

Notably, the exemplary hypersonic aircraft 700 depicted in FIG. 23 is provided by way of example only, and in other embodiments may have any other suitable configuration. For example, in other embodiments, the fuselage 706 may have any other suitable shape (such as a more pointed, aerodynamic shape, different stabilizer shapes and orientation, etc.), the propulsion system may have any other suitable engine arrangement (e.g., an engine incorporated into the vertical stabilizer), any other suitable configuration, etc.

Referring now to FIG. 24, a cross-sectional view of a hypersonic propulsion engine 200 in accordance with an exemplary aspect of the present disclosure is provided. The engine 200 provided in regard to FIG. 24 is configured substantially similarly as shown and described in regard to FIG. 1. It should be appreciated that various embodiments of the engine 200 shown and described in regard to FIG. 24 may be configured to include the RDC system 100 such as shown and described in regard to FIGS. 1-22.

As will be appreciated, the exemplary hypersonic propulsion engine 200 depicted generally includes a turbine engine 202 and a ducting assembly 204. FIG. 24 provides a cross-sectional view of an entire length of the turbine engine 202 (showing all of the ducting assembly 204). Notably, the hypersonic propulsion engine 200 may be incorporated into a hypersonic aircraft (such as the hypersonic aircraft 700 of FIG. 23 as engine 102).

The exemplary hypersonic propulsion engine 200 depicted generally defines an engine inlet 208 at a forward end 211 along the longitudinal direction L and an engine exhaust 213 at an aft end 215 along the longitudinal direction L. Referring to the exemplary turbine engine 202, it will be appreciated that the exemplary turbine engine 202 depicted defines a turbine engine inlet 217, such as may be configured according to the inlet 108 of FIG. 1. The turbine engine 202 further includes a turbine engine exhaust 218, such as may be configured according to the exhaust nozzle 135 of FIG. 1. Furthermore, the exemplary turbine engine 202 includes a compressor section, such as may be configured in regard to compressor section 104 of FIG. 1, a combustion section 205, and a turbine section, such as may be configured in regard to turbine section 106 of FIG. 1. The compressor section, the combustion section 205, and the turbine section are each arranged in serial flow order relative to one another. In various embodiments, the combustion section 205 may include embodiments of the RDC system 100 such as shown and described in regard to FIGS. 1-22. Alternatively, the combustion section 205 may include a deflagrative combustion system.

In regard to the turbine engine 202, the compressor section may include a first compressor 220 having a plurality of sequential stages of compressor rotor blades (including a forward-most stage of compressor rotor blades). Similarly, the turbine section includes a first turbine 224, and further includes a second turbine 227. The first turbine 224 is a high speed turbine coupled to the first compressor 220 through a first engine shaft 229. In such a manner, the first turbine 224 may drive the first compressor 220 of the compressor section. The second turbine 227 is a low speed turbine coupled to a second engine shaft 231.

As will also be appreciated, for the embodiment shown, the hypersonic propulsion engine 200 further includes a fan 232. The fan 232 is located forward (and upstream) of the turbine engine inlet 217. Moreover, the fan 232 includes a fan shaft 234, which for the embodiment shown is coupled to, or formed integrally with the second engine shaft 231, such that the second turbine 227 of the turbine section of the turbine engine 202 may drive the fan 232 during operation of the hypersonic propulsion engine 200. The engine 200 further includes a plurality of outlet guide vanes 233, which for the embodiment depicted are variable outlet guide vanes (configured to pivot about a rotational pitch axis (shown in phantom). The variable outlet guide vanes may further act as struts. Regardless, the variable outlet guide vanes 233 may enable the fan 232 to run at variable speeds and still come out with relatively straight air flow. In other embodiments, the outlet guide vanes 233 may instead be fixed-pitch guide vanes.

Referring still to FIG. 24, the ducting assembly 204 generally includes an outer case 236 and defines a bypass duct 238, the outer case 236 and bypass duct 238 extending around the turbine engine 202. The bypass duct 238 may have a substantially annular shape extending around the turbine engine 202, such as substantially 360 degrees around the turbine engine 202. Additionally, or alternatively, the outer case 236 and/or the bypass duct 238 may define, at least in part, a two-dimensional cross section defining a height and width (e.g., a rectangular cross section). Various embodiments of the outer case 236 and/or the bypass duct 238 may correspond to the RDC system 100 as an annular or two-dimensional configuration. It should be appreciated that in various embodiments, the outer case 236 and/or bypass duct 238 may define an annular portion and a two-dimensional portion.

For the embodiment shown in regard to FIG. 24, the bypass duct 238 extends between a bypass duct inlet 240 and a bypass duct exhaust 242. The bypass duct inlet 240 is aligned with the turbine engine inlet 217 for the embodiment shown, and the bypass duct exhaust 242 is aligned with the turbine engine exhaust 218 for the embodiment shown.

Moreover, for the embodiment shown, the ducting assembly 204 further defines an inlet section 244 located at least partially forward of the bypass duct 238 and an afterburning chamber 246 located downstream of the bypass duct 238 and at least partially aft of the turbine engine exhaust 218. Referring particularly to the inlet section 244, for the embodiment shown, the inlet section 244 is located forward of the bypass duct inlet 240 and the turbine engine inlet 217. Moreover, for the embodiment shown, the inlet section 244 extends from the hypersonic propulsion engine inlet 208 to the turbine engine inlet 217 and bypass duct inlet 240. By contrast, the afterburning chamber 246 extends from the bypass duct exhaust 242 and turbine engine exhaust 218 to the hypersonic propulsion engine exhaust 213 (FIG. 24).

Referring still to FIG. 24, the hypersonic propulsion engine 200 depicted may further include an inlet precooler 248 positioned at least partially within the inlet section 244 of the ducting assembly 204 and upstream of the turbine engine inlet 217, the bypass duct 238, or both (and more particularly, upstream of both for the embodiment shown). The inlet precooler 248 is generally provided for cooling an airflow through the inlet section 244 of the ducting assembly 204 to the turbine engine inlet 217, the bypass duct 238, or both.

During operation of the hypersonic propulsion engine 200, an inlet airflow is received through the hypersonic propulsion engine inlet 208. The inlet airflow passes through the inlet precooler 248, reducing a temperature of the inlet airflow. The inlet airflow then flows into the fan 232. As will be appreciated, the fan 232 generally includes a plurality of fan blades 250 rotatable by the fan shaft 234 (and second engine shaft 231). The rotation of the fan blades 250 of the fan 232 increases a pressure of the inlet airflow. For the embodiment shown, the hypersonic propulsion engine 200 further includes at stage of guide vanes 252 located downstream of the plurality of fan blades 250 of the fan 232 and upstream of the turbine engine inlet 217 (and bypass duct inlet 240). For the embodiment shown, the stage of guide vanes 252 is a stage of variable guide vanes, each rotatable about its respective axis. The guide vanes 252 may change a direction of the inlet airflow from the plurality of fan blades 250 of the fan 232. From the stage guide vanes 252, a first portion of the inlet airflow flows through the turbine engine inlet 217 and along a core air flowpath 254 of the turbine engine 202, and a second portion of the inlet airflow flows through the bypass duct 238 of the ducting assembly 204, as will be explained in greater detail below. Briefly, it will be appreciated that the exemplary hypersonic propulsion engine 200 includes a forward frame, the forward frame including a forward frame strut 256 (and more specifically a plurality of circumferentially spaced forward frame struts 256) extending through bypass duct 238 proximate the bypass duct inlet 240 and through the core air flowpath 254 of the turbine engine 202 proximate the turbine engine inlet 217.

Generally, the first portion of air passes through the first compressor 220, wherein a temperature and pressure of such first portion of air is increased and provided to the combustion section 205. The combustion section 205 includes a plurality of fuel nozzles 258 spaced along the circumferential direction C for providing a mixture of oxidizer, such as compressed air, and a liquid and/or gaseous fuel to a combustion chamber (e.g., detonation chamber 122) of the combustion section 205. In various embodiments, the plurality of fuel nozzles 258 of the engine 200 are arranged and configured according to one or more embodiments of the plurality of fuel injectors 128 of the RDC system 100 shown and described herein.

The compressed air and fuel mixture is burned to generate combustion gases, which are provided through the turbine section. The combustion gases are expanded across the first turbine 224 and second turbine 227, driving the first turbine 224 (and first compressor 220 through the first engine shaft 229) and the second turbine 227 (and fan 232 through the second engine shaft 231). The combustion gases are then exhausted through the turbine engine exhaust 218 and provided to the afterburning chamber 246 of the ducting assembly 204.

As is depicted schematically, the hypersonic propulsion engine 200, and in particular, the turbine engine 202, includes a plurality of bearings 260 for supporting one or more rotating components of the hypersonic propulsion engine 200. For example, the exemplary hypersonic propulsion engine 200/turbine engine 202 depicted includes one or more bearings 260 supporting the first engine shaft 229 and the second engine shaft 231. For the embodiment shown, the one or more bearings 260 are configured as air bearings. It will be appreciated, however, that in other exemplary embodiments, the one or more bearings 260 may be formed in any other suitable manner. For example, in other embodiments, one or more of the bearings 260 may be roller bearings, ball bearings, etc.

Referring still to FIG. 24, the second portion of the inlet airflow, as noted above, is provided through the bypass duct 238. Notably, for the embodiment shown, the bypass duct 238 includes a dual stream section. The dual stream section includes an inner bypass stream 262 and an outer bypass stream 264. The inner bypass stream 262 and outer bypass stream 264 are in a parallel flow configuration and, for the embodiment shown, extend at least partially outward of the first compressor 220 of the compressor section of the turbine engine 202. Notably, for the embodiment shown, the ducting assembly 204 includes an outer bypass stream door 266 located at an upstream end of the outer bypass duct stream 264. The outer bypass duct stream door 266 is movable between a closed position (shown) and an open position (depicted in phantom). The outer bypass stream door 266 substantially completely blocks the outer bypass stream 264 when in the closed position, such that substantially all of the second portion of the inlet airflow received through the bypass duct 238 flows through the inner bypass stream 262. By contrast, the outer bypass stream door 266 allows airflow through the outer bypass stream 264 when in the open position. Notably, the ducting assembly 204 is designed aerodynamically such that when the outer bypass stream door 266 is in the open position during hypersonic flight operating conditions, a ratio of an amount of airflow through the outer bypass duct stream 264 to an amount of airflow through the inner bypass duct 262 stream is greater than 1:1, such as greater than about 2:1, such as greater than about 4:1, and less than about 100:1, such as less than about 10:1.

Referring still to the dual stream section, and more particularly to the inner bypass stream 262, it will be appreciated that for the embodiment shown the ducting assembly 204 further includes a stage of airfoils 268 positioned at least partially within the inner bypass stream 262. More particularly, for the embodiment shown, each compressor rotor blade of the forward-most stage of compressor rotor blades 222 of the first compressor 220 of the turbine engine 202 defines a radially outer end. The stage of airfoils 268 of the ducting assembly 204 is coupled to the forward-most stage of compressor rotor blades 222 at the radially outer ends. In such a manner, the stage of airfoils 268 is configured to be driven by, and rotate with the first compressor 220 during at least certain operations. For the embodiment shown, the stage of airfoils 268 of the ducting assembly 204 is a stage of compression airfoils configured to compress the second portion of air flowing through the inner bypass duct stream 262, increasing a pressure and/or flowrate of such airflow.

Downstream of the dual stream section of the bypass duct 238, the second portion of the inlet airflow is merged back together and flows generally along the longitudinal direction L to the bypass duct exhaust 242. For the embodiment shown, the airflow through the bypass duct 238 is merged with the exhaust gases of the turbine engine 202 at the afterburning chamber 246. The exemplary hypersonic propulsion engine 200 depicted includes a bypass airflow door 270 located at the turbine engine exhaust 218 and bypass duct exhaust 242. The bypass airflow door 270 is movable between an open position (shown) wherein airflow through the core air flowpath 254 of the turbine engine 202 may flow freely into the afterburning chamber 246, and a closed position (depicted in phantom), wherein airflow from the bypass duct 238 may flow freely into the afterburning chamber 246. Notably, the bypass airflow door 270 may further be movable between various positions therebetween to allow for a desired ratio of airflow from the turbine engine 202 to airflow from the bypass duct 238 into the afterburning chamber 246.

During certain operations, such as during hypersonic flight operations, further thrust may be realized from the airflow into and through the afterburning chamber 246. More specifically, for the embodiment shown, the hypersonic propulsion engine 200 further includes an augmenter 272 positioned at least partially within the afterburning chamber 246. Particularly, for the embodiment shown, the augmenter 272 is positioned at an upstream end of the afterburning chamber 246, and more particularly, immediately downstream of the bypass duct exhaust 242 and turbine engine exhaust 218.

Notably, for the embodiment shown, the afterburning chamber 246 is configured as a hyperburner chamber, and the augmenter 272 incorporates a rotating detonation combustor 274, such as embodiments of the RDC system 100 shown and described in regard to FIGS. 1-22. In particular embodiments, the augmenter 272 includes the plurality of fuel injectors 128 configured such as shown and described in regard to FIGS. 1-6. It should further be appreciated that embodiments of the afterburning chamber 246 may correspond, at least in part, to the detonation chamber 122 configured such as shown and described in regard to FIGS. 1-6.

Further, referring back to FIG. 24, it will be appreciated that the afterburning chamber 246 extends generally to the hypersonic propulsion engine exhaust 213, defining a nozzle outlet 282 at the hypersonic propulsion engine exhaust 213. Moreover, the afterburning chamber 246 defines an afterburning chamber axial length 284 between the turbine engine exhaust 218 and the hypersonic propulsion engine exhaust 213. In various embodiments, the afterburning chamber axial length 284 corresponds to the detonation chamber length 123 of the RDC system 100 shown and described in regard to FIGS. 1-22. In particular embodiments, the hypersonic propulsion engine exhaust 213 corresponds to the detonation chamber outlet 126 such as shown and described herein. Similarly, the turbine engine 202 defines a turbine engine axial length 286 between the turbine engine inlet 217 and the turbine engine exhaust 218. For the embodiment depicted, the afterburning chamber axial length 284 is at least about fifty percent of the turbine engine axial length 286 and up to about 500 percent of the turbine engine axial length 286. More particularly, for the embodiment shown, the afterburning chamber axial length 284 is greater than the turbine engine axial length 286. For example, in certain embodiments, the afterburning chamber 246 may define an afterburning chamber axial length 284 that is at least about 125 percent of the turbine engine axial length 286, such as at least about 150 percent of the turbine engine 202. However, in other embodiments (such as embodiments incorporating the rotating detonation combustor 274), the afterburning chamber axial length 284 may be less than the turbine engine axial length 286.

Moreover, it will be appreciated that in at least certain exemplary embodiments, the hypersonic propulsion engine 200 may include one or more components for varying a cross-sectional area of the nozzle outlet 282. As such, the nozzle outlet 282 may be a variable geometry nozzle outlet configured to change in cross-sectional area based on e.g., one or more flight operations, ambient conditions, or operating modes of the RDC system 100 (e.g., to sustain rotating detonation of the fuel/oxidizer mixture), etc.

For the embodiment shown, it will be appreciated that the exemplary hypersonic propulsion engine 200 further includes a fuel delivery system 288. The fuel delivery system 288 is configured for providing a flow fuel to the combustion section 205 of the turbine engine 202, and for the embodiment shown, the augmenter 272 positioned at least partially within the afterburning chamber 246. Embodiments of the engine 200 include the controller 210 such as shown and described in regard to FIG. 1. The exemplary fuel delivery system 288 depicted generally includes a fuel tank 290 and a fuel oxygen reduction unit 292. The fuel oxygen reduction unit 292 may be configured to reduce an oxygen content of the fuel flow from the fuel tank 290 and through the fuel delivery system 288.

The fuel delivery system 288 further includes a fuel pump 264 configured to increase a pressure of the fuel flow through the fuel delivery system 288. Further, for the embodiment shown the inlet precooler 248 is a fuel-air heat exchanger thermally coupled to the fuel delivery system 288. More specifically, for the embodiment shown, the inlet precooler 248 is configured to utilize fuel directly as a heat exchange fluid, such that heat extracted from the inlet airflow through the inlet section 244 of the ducting assembly 204 is transferred to the fuel flow through the fuel delivery system 288. For the embodiment shown, the heated fuel (which may increase in temperature by an amount corresponding to an amount that the inlet airflow temperature is reduced by the inlet precooler 248, as discussed above) is then provided to the combustion section 205 and/or the augmenter 272. Notably, in addition to acting as a relatively efficient heat sink, increasing a temperature of the fuel prior to combustion may further increase an efficiency of the hypersonic propulsion engine 200.

In various embodiments, the fuel delivery system 288 is in operable communication with the controller 210 to receive and/or send data, instructions, or feedback between one another. The fuel delivery system 288, the controller 210, and the RDC system 100, such as positioned at the combustion section 202 and/or the afterburning chamber 236, may be in communication and operably coupled to one another. In particular embodiments, the fuel delivery system 288 is configured to provide flow rates, pressures, temperatures, densities, or other fuel flow characteristics to flows of fuel corresponding to desired fuel/oxidizer mixtures from the fuel injectors 128. The fuel delivery system 288 may further be in operable communication with the controller 210 to provide respective flows of liquid and/or gaseous fuel to the RDC system 100, such as may be positioned at the combustion section 202 and/or the afterburning chamber 236. In particular embodiments, the fuel delivery system 288 may provide flows of fuel in thermal communication with the inlet precooler 248 based, at least in part, on a desired unidirectional pressure wave propagation corresponding to sustaining the detonation wave 130.

Embodiments shown and described in regard to FIGS. 1-24 may include elements, features, reference numerals, details, or methods for operation shown or described in regard to one figure and not necessarily shown or described in regard to another figure. It should further be appreciated that one or more figures may omit certain features for the sake of clarity. Furthermore, elements, features, reference numerals, details, or descriptions or depictions of method for operation may be distributed across two or figures for the sake of clarity. It should be appreciated that elements, features, reference numerals, details, or methods shown or described in regard to one figure are applicable to any or all other figures provided herein unless otherwise stated. As such, combinations of elements, features, reference numerals, details, or methods shown or described herein in regard to two or more figures may constitute an embodiment within the scope of the present disclosure as if depicted together in a single figure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

1. A system for rotating detonation combustion, the system including an inner wall and an outer wall each extended around a centerline axis, wherein a detonation chamber is defined between the inner wall and the outer wall. The system includes an iterative structure positioned at one or both of the inner wall or the outer wall, wherein the iterative structure comprises a first threshold structure corresponding to a first pressure wave attenuation and a second threshold structure corresponding to a second pressure wave attenuation. The iterative structure provides for pressure wave strengthening along a first circumferential direction in the detonation chamber or pressure wave weakening along a second circumferential direction opposite of the first circumferential direction. The first circumferential direction corresponds to a desired direction of pressure wave propagation in the detonation chamber.

2. The system of any preceding clause, wherein the iterative structure includes an arcuate portion, the arcuate portion including the first threshold structure and the second threshold structure.

3. The system of any preceding clause, wherein the iterative structure includes a waveform extended along a radial direction from one or more of the inner wall or the outer wall.

4. The system of any preceding clause, wherein the iterative structure including a waveform further includes a first wall and a second wall together defining a ramp structure extended from along circumferentially in the detonation chamber, the ramp structure extended radially from one or more of the inner wall or the outer wall.

5. The system of any preceding clause, wherein the waveform includes one or more of a triangle wave, a box wave, a sawtooth wave, a sine wave, or combinations thereof.

6. The system of any preceding clause, wherein the second wall is extended at least partially tangentially or substantially tangentially from the first wall to the inner wall or the outer wall to which the first wall is connected.

7. The system of any preceding clause, wherein the second wall is extended concave, convex, or sinusoidal from the first wall at the first radial height to the inner wall or the outré wall to which the first wall is connected.

8. The system of any preceding clause, wherein the iterative structure includes two or more arcuate portions at the detonation chamber, wherein each arcuate portion of the iterative structure includes a radial wall extended to a first radial height from one or more of the inner wall or the outer wall, and a second wall extended from the first radial height at the radial wall to the inner wall or the outer wall to which the radial wall is connected.

9. The system of any preceding clause, wherein the second wall is extended from the radial wall along the desired direction of pressure wave propagation in the detonation chamber.

10. The system of any preceding clause, wherein the first radial height is between 3% and 50% of a flowpath height, wherein the flowpath height is extended from the inner wall to the outer wall.

11. The system of any preceding clause, wherein the first radial height is between 3% and 25% of a flowpath height, wherein the flowpath height is extended from the inner wall to the outer wall.

12. The system of any preceding clause, wherein the second wall is extended at least partially tangentially from the first wall to the inner wall or the outer wall to which the first wall is connected.

13. The system of any preceding clause, wherein the system iterative structure includes two or more arcuate portions in circumferential arrangement in the detonation chamber.

14. The system of any preceding clause, wherein the system includes between two and two-hundred arcuate portions of the iterative structure in circumferential arrangement in the detonation chamber.

15. The system of any preceding clause, wherein the iterative structure includes a first radial wall extended to a first radial height from one or more of the inner wall or the outer wall, a second radial wall extended from one or more of the inner wall or the outer wall to a second radial height less than the first radial height, a first ramp wall extended from the first radial height at the first radial wall to the inner wall or the outer wall from which the first radial wall is extended, and a second ramp wall extended from the second radial height at the second radial wall to the inner wall or the outer wall from which the second radial wall is extended.

16. The system of any preceding clause, wherein the first ramp wall and the second ramp wall each extend along the desired direction of pressure wave propagation to the inner wall or the outer wall.

17. The system of any preceding clause, further including a fuel injector extended along a longitudinal direction, wherein a fuel injector outlet is positioned in an area between the second wall and the first wall.

18. The system of any preceding clause, wherein the fuel injector outlet is positioned between the inner wall or the outer wall from which the first wall is extended and the first radial height of the first wall.

19. The system of any preceding clause, wherein the fuel injector outlet is positioned upstream of the ramp structure.

20. The system of any preceding clause, wherein the fuel injector is positioned at a substantially tangential angle relative to a detonation path in the detonation chamber.

21. The system of any preceding clause, wherein the angle is between 0 degrees and 90 degrees toward the desired direction of pressure wave propagation.

22. The system of any preceding clause, wherein the iterative structure includes a plurality of fuel injectors each extended along a longitudinal direction.

23. The system of any preceding clause, wherein the plurality of fuel injectors is each extended along a tangential direction toward the desired direction of pressure wave propagation.

24. The system of any preceding clause, wherein the plurality of fuel injectors each include a convergent-divergent nozzle.

25. The system of any preceding clause, wherein the plurality of fuel injectors each include an outer fuel injector wall configured to generate a Coanda effect of fuel flow from the convergent-divergent nozzle to the detonation chamber.

26. The system of any preceding clause, wherein the plurality of fuel injectors each includes an outer fuel injector wall comprising a longitudinal portion defining a fuel passage, and an angled wall relative to a fuel injector centerline axis, wherein an angle of the angled wall corresponds to a discharge coefficient.

27. The system of any preceding clause, wherein the angle of the angled wall is between 0 degrees and 90 degrees.

28. The system of any preceding clause, wherein the plurality of fuel injectors is arranged in order of increasing discharge coefficient along the desired direction of pressure wave propagation.

29. The system of any preceding clause, wherein the plurality of fuel injectors includes a minimum discharge coefficient fuel injector and a maximum discharge coefficient fuel injector, wherein the minimum discharge coefficient fuel injector is positioned circumferentially sequential to the maximum discharge coefficient fuel injector.

30. The system of any preceding clause, wherein the iterative structure comprises two or more plurality of fuel injectors, wherein each plurality of fuel injectors includes a maximum discharge coefficient fuel injector sequentially after a minimum discharge coefficient fuel injector along the desired direction of pressure wave propagation.

31. The system of any preceding clause, wherein the iterative structure further includes one or more intermediate discharge coefficient fuel injectors positioned between the minimum discharge coefficient fuel injector and the maximum discharge coefficient fuel injector.

32. The system of any preceding clause, wherein a change in discharge coefficient from the minimum discharge coefficient fuel injector to the maximum discharge coefficient fuel injector is between a multiple of two and a multiple of three.

33. The system of any preceding clause, wherein the system includes between two and forty iterative structures in circumferential arrangement, wherein the iterative structures is arranged in repeating arcs along the desired direction of pressure propagation.

34. The system of any preceding clause, wherein the repeating arcs of the iterative structure is between 9 degree arcs and 180 degree arcs.

35. The system of any preceding clause, wherein the iterative structure includes a plurality of dampers arranged in order of increasing or decreasing target pressure attenuation frequency.

36. The system of any preceding clause, wherein the plurality of dampers includes a minimum attenuation target damper and a maximum attenuation target damper, wherein the minimum attenuation target damper is positioned circumferentially sequential to the maximum attenuation target damper.

37. The system of any preceding clause, wherein the iterative structure includes two or more pluralities of dampers, wherein each plurality of dampers comprises a maximum attenuation target damper sequentially after a minimum attenuation target damper along the desired direction of pressure wave propagation.

38. The system of any preceding clause, wherein the iterative structure further includes one or more intermediate attenuation target dampers positioned between the minimum attenuation target damper and the maximum attenuation target damper.

39. The system of any preceding clause, wherein the system includes between two and forty arcuate portions of the iterative structure in circumferential arrangement, wherein the iterative structure is arranged in repeating arcs along the desired direction of pressure propagation.

40. The system of any preceding clause, wherein the repeating arcs of the iterative structure is between 9 degree arcs and 180 degree arcs.

41. The system of any preceding clause, wherein the plurality of dampers each define Helmholtz adapters configured to target frequencies based at least on a desired pressure wave attenuation relative to the desired direction of pressure wave propagation.

42. The system of any preceding clause, including a plurality of fuel injectors, wherein the damper includes a fuel cavity from which a flow of fuel is provided to two or more fuel injectors of the plurality of fuel injectors.

43. The system of any preceding clause, wherein the plurality of dampers is arranged in sequential arrangement and configured in increasing pressure frequency attenuation relative to the desired direction of pressure wave propagation.

44. The system of any preceding clause, wherein the minimum attenuation damper is positioned circumferentially adjacent to a predetonation device relative to the desired direction of pressure wave propagation.

45. The system of any preceding clause, including a first fuel circuit configured to provide a flow of fuel to a first fuel nozzle, wherein the first fuel circuit is fluidly coupled to a first damper, and wherein the system includes a second fuel circuit configured to provide the flow of fuel to a second fuel nozzle, wherein the second fuel nozzle is circumferentially adjacent to the first fuel nozzle along the desired direction of pressure propagation, and wherein the second fuel circuit is fluidly coupled to a second damper.

46. The system of any preceding clause, wherein the first damper is configured to a pressure frequency attenuation less than the second damper.

47. The system of any preceding clause, wherein the iterative structure comprises one or more of the fuel nozzle, the fuel injector, the damper, the ramp structure, or the fuel circuit, or combinations thereof.

48. A heat engine comprising the system of any preceding clause.

49. A turbo machine comprising the system of any preceding clause.

50. A hypersonic propulsion system comprising the system of any preceding clause.

51. A vehicle comprising the system of any preceding clause.

What is claimed is:

1. A system for rotating detonation combustion, the system comprising:
an inner wall and an outer wall each extended around a centerline axis, wherein a detonation chamber is defined between the inner wall and the outer wall;
an iterative structure positioned at one or both of the inner wall or the outer wall, wherein the iterative structure comprises a first threshold structure corresponding to a first pressure wave attenuation and a second threshold structure corresponding to a second pressure wave attenuation, wherein the iterative structure provides for pressure wave strengthening along a first circumferential direction in the detonation chamber or pressure wave weakening along a second circumferential direction opposite of the first circumferential direction, and wherein the first circumferential direction corresponds to a desired direction of pressure wave propagation in the detonation chamber.

2. The system of claim 1, wherein the iterative structure comprises an arcuate portion, wherein the arcuate portion comprises the first threshold structure and the second threshold structure.

3. The system of claim 1, wherein the iterative structure comprises a waveform extended along a radial direction from one or more of the inner wall or the outer wall.

4. The system of claim 3, wherein the iterative structure comprising a waveform further comprises a first wall and a second wall together defining a ramp structure extended from along circumferentially in the detonation chamber, the ramp structure extended radially from one or more of the inner wall or the outer wall.

5. The system of claim 3, wherein the waveform comprises one or more of a triangle wave, a box wave, a sawtooth wave, a sine wave, or combinations thereof.

6. The system of claim 3, wherein the second wall is extended substantially tangentially from the first wall to the inner wall or the outer wall to which the first wall is connected.

7. The system of claim 3, wherein the second wall is extended concave, convex, or sinusoidal from the first wall at the first radial height to the inner wall or the outré wall to which the first wall is connected.

8. The system of claim 1, wherein the iterative structure comprises two or more arcuate portions at the detonation chamber, wherein each arcuate portion of the iterative structure comprises a radial wall extended to a first radial height from one or more of the inner wall or the outer wall, and a second wall extended from the first radial height at the radial wall to the inner wall or the outer wall to which the radial wall is connected.

9. The system of claim 8, wherein the second wall is extended from the radial wall along the desired direction of pressure wave propagation in the detonation chamber.

10. The system of claim 8, wherein the first radial height is between 3% and 50% of a flowpath height, wherein the flowpath height is extended from the inner wall to the outer wall.

11. The system of claim 8, wherein the first radial height is between 3% and 25% of a flowpath height, wherein the flowpath height is extended from the inner wall to the outer wall.

12. The system of claim 8, wherein the second wall is extended at least partially tangentially from the first wall to the inner wall or the outer wall to which the first wall is connected.

13. The system of claim 1, wherein the system iterative structure comprises two or more arcuate portions in circumferential arrangement in the detonation chamber.

14. The system of claim 13, wherein the system comprises between two and two-hundred arcuate portions of the iterative structure in circumferential arrangement in the detonation chamber.

15. The system of claim 1, wherein the iterative structure comprises:
a first radial wall extended to a first radial height from one or more of the inner wall or the outer wall;
a second radial wall extended from one or more of the inner wall or the outer wall to a second radial height less than the first radial height;
a first ramp wall extended from the first radial height at the first radial wall to the inner wall or the outer wall from which the first radial wall is extended; and
a second ramp wall extended from the second radial height at the second radial wall to the inner wall or the outer wall from which the second radial wall is extended.

16. The system of claim 15, wherein the first ramp wall and the second ramp wall each extend along the desired direction of pressure wave propagation to the inner wall or the outer wall.

17. The system of claim 3, further comprising:
a fuel injector extended along a longitudinal direction, wherein a fuel injector outlet is positioned in an area between the second wall and the first wall.

18. The system of claim 17, wherein the fuel injector outlet is positioned between the inner wall or the outer wall from which the first wall is extended and the first radial height of the first wall.

19. The system of claim 17, wherein the fuel injector outlet is positioned upstream of the ramp structure.

20. The system of claim 17, wherein the fuel injector is positioned at a substantially tangential angle relative to a detonation path in the detonation chamber toward the desired direction of pressure wave propagation.
